(19) United States
(12) Patent Application Publication
(10) Pub. No.: US 2017/0149171 A1
(43) Pub. Date: May 25, 2017

(54) MAGNETIC CONNECTORS FOR PHYSICAL CONNECTION AND DATA AND POWER EXCHANGE BETWEEN DEVICES

(71) Applicant: Nanoport Technology Inc., Markham, CA (US)

(72) Inventor: Timothy Jing Yin Szeto, Mississauga (CA)

(21) Appl. No.: 15/356,455

(22) Filed: Nov. 18, 2016

Related U.S. Application Data
(60) Provisional application No. 62/281,108, filed on Jan. 20, 2016.
(60) Provisional application No. 62/258,463, filed on Nov. 21, 2015.

(51) Int. Cl. H01R 13/62; H01R 43/26

(52) U.S. Cl. CPC H01R 13/6205; H01R 43/26

(57) ABSTRACT

A system of connecting two or more communication devices wherein the system comprises of at least two devices, each of which has an interface and a housing with a peripheral surface, and a connector. The devices are positioned at the interfaces through a connector. The housing is configured to receive a magnetic contact assembly. A method of connecting two or more devices wherein the method comprises of positioning a connector of a first device adjacent a connector of a second device; magnetically drawing a magnet of said first device toward said second device to magnetically hold said first and second devices together, thereby overcoming a magnetic bias between said magnet and a contact assembly of said first device; and magnetically drawing said contact assembly toward said second device to form a mechanical connection.

### CROSS-REFERENCE TO RELATED APPLICATIONS

The present application claims priority to U.S. Provisional Application No. 62/281,108, filed Jan. 20, 2016 and U.S. Provisional Application No. 62/258,463, filed Nov. 21, 2015, both of which are incorporated herein by reference in their entirety.

### TECHNICAL FIELD

Embodiments of the present invention generally relate to magnetic connectors, and more specifically to systems and methods that provide a mechanical connection between two or more devices and that transmit data and/or power between the devices using magnetic connectors.

### BACKGROUND

Electronic devices (e.g., mobile phones, tablet computers, laptop computers, etc.) are usually provided with a plurality of connection options which allow the devices to communicate with one another electronically, or to supply energy to the internal battery to recharge the battery, or to add functionality to the device, such as connecting a peripheral device (e.g., keyboard, mouse, speakers, camera, etc.).

Connection of devices mechanically and/or electrically integrates the multiple devices to provide complementary functions. To establish such connections, it is necessary to orientate the devices relative to one another and to facilitate mechanical and/or electrical communication between the devices, e.g., using contacts, ports, sockets, and other interfaces, which may be collectively referred to as connectors. The relative orientation of the devices is obtained through mechanical connections. It is desirable that these mechanical connections be robust, simple to use, and aesthetically pleasing.

Electrical communication between the devices is typically provided either through wires or through wireless communications. Wires or cables are cumbersome to carry and increase the physicality of the devices. Provision must also be made on the device to permit connection of the cables to the device, which again presents aesthetic challenges to the design of the device. Wireless connections are less secure and require more energy and therefore consume more power from the battery and are subject to interference from external sources.

Therefore, it is desirable to provide an improved connector, and methods and systems that use the improved connector, to mitigate the aforementioned problems by effectively connecting devices and transmitting data and power between the devices.

### SUMMARY

The embodiments described herein are directed to systems of connecting two or more devices wherein such a system comprises of at least two communication devices, each of which has an interface and a housing with a peripheral surface, and a connector. The devices are positioned adjacent to each other at the interfaces through a connector. The housing is configured to receive a magnetic contact assembly.

The embodiments described herein are also directed to methods of connecting two or more devices wherein the method comprises of positioning a connector of a first device adjacent a connector of a second device; magnetically drawing a magnet of said first device toward said second device to magnetically hold said first and second devices together, thereby overcoming a magnetic bias between said magnet and a contact assembly of said first device; and magnetically drawing said contact assembly toward said second device to form a mechanical connection.

This summary and the following detailed description are merely exemplary, illustrative, and explanatory, and are not intended to limit, but to provide further explanation of the invention as claimed. Other systems, methods, features, and advantages of the example embodiments will be or will become apparent to one skilled in the art upon examination of the following figures and detailed description.

### BRIEF DESCRIPTION OF THE DRAWINGS

The figures provided are diagrammatic and not drawn to scale. Variations from the embodiments pictured are contemplated. Accordingly, illustrations in the figures are not intended to limit the scope of the invention.

FIGS. 1A, 1B, and 1C are perspective views of a pair of electronic devices, in three respective configurations.

FIGS. 2A and 2B are schematic views showing components of an electronic device.

FIGS. 2C, 2D, 2E, 2F, 2G, and 2H are schematic views showing locations of magnetic connectors on an electronic device.

FIG. 3A is a top view of a magnetic connector with biasing side magnets.

FIG. 3B is a schematic view of two magnetic connectors of FIG. 3A when engaged.

FIG. 3C is a perspective view of the magnetic connector of FIG. 3A.

FIG. 3D is a perspective cross-sectional view of the magnetic connector of FIG. 3A.

FIG. 3E is a side cross-sectional view of the magnetic connector of FIG. 3A.

FIG. 3F is a top view of the magnetic connector of FIG. 3A, showing example dimensions.

FIG. 4A is a top view of another magnetic connector with a biasing side magnet.

FIG. 4B is a schematic view of two magnetic connectors of FIG. 4A when engaged.

FIGS. 5A, 5B, and 5C are top, front, and side cross-sectional views, respectively, of another magnetic connector.

FIGS. 5D and 5E are top and side cross-sectional views, respectively, of two magnetic connectors of FIG. 5A when engaged.

FIG. 6A is a top view of two magnetic connectors when engaged.

FIG. 6B is a side view of the magnetic connectors of FIG. 6A.

FIGS. 6C and 6D are perspective views of another magnetic connector.

FIGS. 7A and 7B are perspective views of another magnetic connector, when disengaged and engaged, respectively.

FIGS. 8A, 8B, and 8C are perspective, top, and side views, respectively, of a magnet of the connector of FIG. 7A.

FIGS. 9A, 9B, and 9C are perspective, front, and top views, respectively, of another magnetic connector.

FIGS. 10A, 10B, and 10C are perspective views of another magnetic connector.

FIGS. 11A, 11B, and 11C are perspective, top, and side cross-sectional views of another magnetic connector.

FIGS. 11D and 11E are side cross-sectional views of two magnetic connectors of FIG. 11A when engaged in two different orientations.

FIG. 12A is a perspective view of a device including another magnetic connector.

FIGS. 12B and 12C are top and side cross-sectional views, respectively, of the magnetic connector of FIG. 12A.

FIG. 13A is a perspective view of two devices including magnetic connectors of FIG. 12A, engaged in a first orientation.

FIGS. 13B and 13C are cross-sectional views of the magnetic connectors of FIGS. 13A.

FIG. 14A is a perspective view of two devices including magnetic connectors of FIGS. 12A, engaged in a second orientation.

FIGS. 14B and 14C are cross-sectional views of the magnetic connectors of FIG. 14A.

FIG. 15A is a perspective view of two devices including magnetic connectors of FIG. 12A, engaged in a third orientation.

FIGS. 15B and 15C are cross-sectional views of the magnetic connectors of FIG. 15A.

FIGS. 16A and 16B are perspective views of another magnetic connector, in the disengaged and engaged state, respectively.

FIGS. 17A and 17B are perspective views of another magnetic connector, in the disengaged and engaged state, respectively.

FIGS. 18A, 18B, and 18C are perspective, side, and top views, respectively, of a component of the magnetic connector of FIG. 17A.

FIGS. 19A, 19B, and 19C are perspective, front, and top views, respectively, of another magnetic connector.

FIG. 20A is a perspective view of another magnetic connector in a disengaged state.

FIG. 20B is a top view of the magnetic connector of FIG. 20A.

FIG. 20C is a top view of two magnetic connectors of FIG. 20A in an engaged state.

FIG. 21A is side view of a magnetic connector assembly.

FIG. 21B is an exploded side view of the magnetic connector assembly of FIG. 21A.

FIG. 22A is a side view of a magnetic connector assembly.

FIG. 22B is an exploded side view of the magnetic connector assembly of FIG. 22A.

FIG. 22C is a schematic view of a plug of the magnetic connector of FIG. 22A.

FIG. 23A is a side view of a magnetic connector assembly.

FIG. 23B is an exploded side view of the magnetic connector assembly of FIG. 23A.

FIGS. 24A and 24B are side views of a sleeve of the magnetic connector assembly of FIG. 23A.

FIGS. 25A, 25B, and 25C are front views of a device with attached magnetic connectors.

FIG. 26 illustrates a computing system that includes various examples of devices with magnetic connectors.

FIG. 27 is a perspective view of a gamepad with attached magnetic connectors.

FIG. 28 is a top view of a controller with buttons, tabs, and magnetic connectors represented on a touch screen input device.

FIG. 29 is a top view of a modified fiber optic version of FIG. 3A.

FIG. 30 illustrates magnetic connector devices linked to a server and a database.

FIG. 31 is a bottom view of a device connected to magnetic connectors.

FIG. 32 is a perspective view of a system with multiple users connected to the same device via magnetic connectors.

### DETAILED DESCRIPTION

The disclosure herein describes magnetic connectors, examples of which can be found at www.nanomagnetics.com. In some embodiments, magnetic connectors are configured to provide only a mechanical connection between two or more devices. In some embodiments, magnetic connectors are configured to provide a mechanical connection, and/or also transmit data between the devices. In some embodiments, magnetic connectors are configured to provide a mechanical connection, and/or power between the devices.

In some embodiments, the data can include control data from one magnetic device to control another magnetic device. In some instances, the data transferred from one magnetic device to another magnetic device can include data received from sensors. The data received from sensors can be obtained from a first magnetic device by a second magnetic device and be used by the second magnetic device in a processor of the second magnetic device to create an amalgam of the two devices that work collaboratively to provide a useful device constituted by the combination of both magnetic devices.

This disclosure herein further describes examples of interactions between devices incorporating magnetic or similar connectors, and describes a software framework for facilitating user interaction with devices, and for facilitating sharing of hardware resources amongst devices, instantiation of sessions for such devices, and for multiple users and/or user profiles.

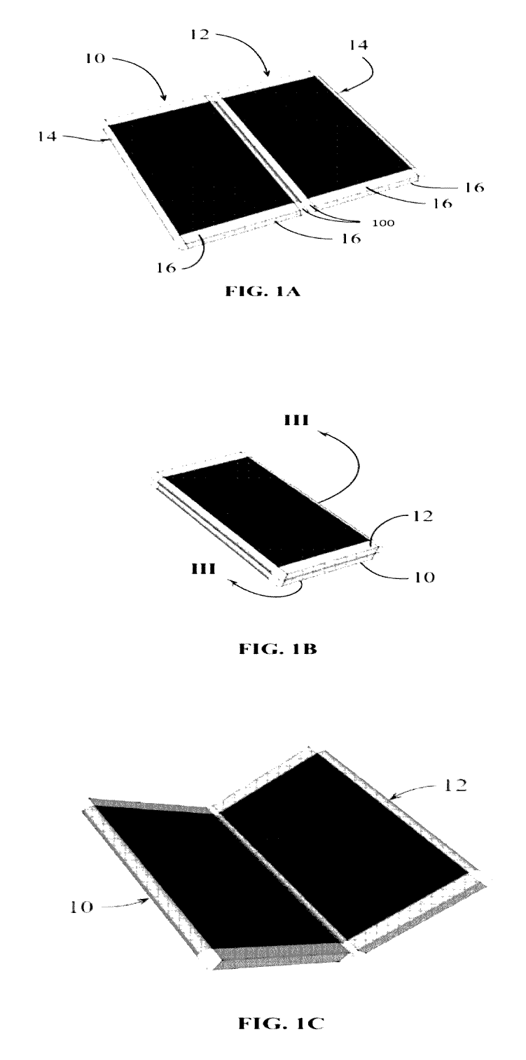

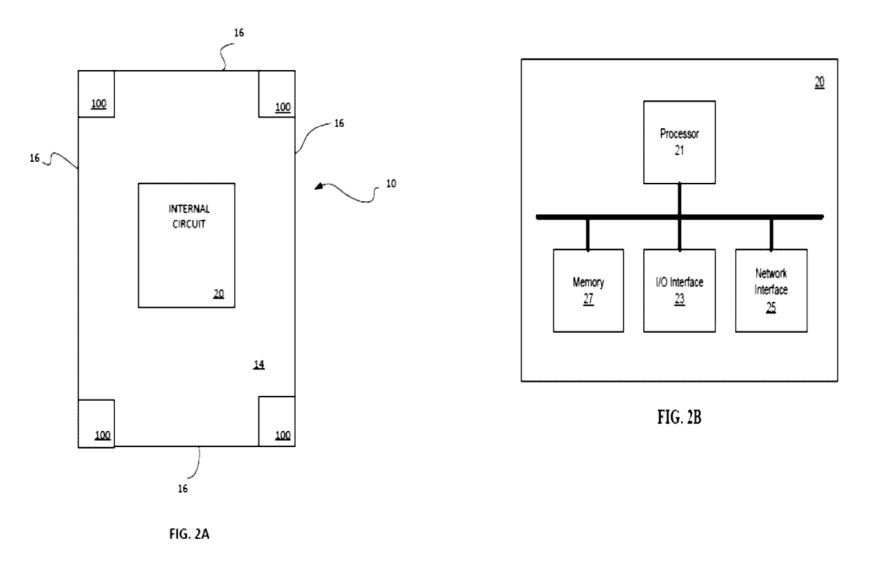

FIGS. 1A, 1B, and 1C illustrate a pair of electronic devices 10 and 12, and each include a housing 14 defined by contiguous external surfaces 16. The devices 10 and 12 may be any electronic devices that interface with one another and provide complementary functions. In an embodiment, each device is a smartphone. In other embodiments, one device may be smartphone and the other an accessory, such as a speaker. In other embodiments, one of the devices may be a smartphone and the other a viewing screen; or both may be viewing screens; or one may be a screen and the other a keyboard; or one device may be a touchscreen enabled device and the other a router to communicate to the Internet; or one may be a camera and the other a smart phone to store images from the camera; etc. These embodiments are merely exemplary and are non-limiting. It will be apparent to one skilled in the art that many mutually complementary devices can function as the pair of electronic devices 10 and 12. Electronic devices, such as 10, 12, and other electronic devices illustrated and described herein, can also be called communication devices since they are capable of communicating with each other and/or a server, database, and/or the end user.

As illustrated in FIG. 1A, the devices 10 and 12 may be arranged side by side with a pair of surfaces 16, e.g. lateral surfaces, juxtaposed, typically when in use, or, as illustrated in FIG. 1B, in a stacked configuration with a different pair of surfaces, e.g. front and back surfaces, juxtaposed for storage or for alternative functions.

Devices 10 and 12 include connectors 100 at each corner of their respective housings. As described in further detail below, each connector 100 may include one or more magnets movably mounted within the respective device housing 14. Such magnets may be made from rare earth materials, such as Neodymium-Iron-Boron (NdFeB), Samarium-cobalt, as are generally available. Such magnets may also be made from iron, nickel, or other suitable alloys. Alternatively, or additionally, each connector may include one or more members susceptible to movement by magnetic fields, e.g. metallic or ferromagnetic members. Indicators may be incorporated into the housing 14 to provide an indication of the state of the connectors 100 (e.g., the location or orientation of a magnet). The indicators may be conveniently made from a magnetically transparent material, such as aluminum or copper that also enhances the aesthetics of the casing.

Devices 10 and 12 may be used in a variety of positions. For example, two devices may be placed side-by-side, with lateral surfaces 16 abutting, as illustrated in FIG. 1A. Devices may also be placed on top of one another, so that a top or bottom surface of one device abuts a top or bottom surface of another device as illustrated in FIG. 1B. In some embodiments, devices may be placed side-by-side and pivoted relative to one another, as illustrated in FIG. 1C. In each of the illustrated orientations, respective connectors 100 of the two devices are positioned proximate one another. It will be apparent to one skilled in the art that other orientations are possible.

With the devices 10 and 12 in the position of FIG. 1A, a connector 100 of one device 10 is positioned adjacent a connector 100 of the other device 12. In this position, the magnets of the connectors 100 are adjacent one another. In that position, the magnets of the adjacent connectors 100 may interact to magnetically or electrically engage one another. For example, one or more of magnets may slide or rotate so that that the respective north and south poles of adjacent magnets are aligned. As further detailed below, in some embodiments, once the magnets are engaged, an electrical connection may be formed for providing data and/or power paths. In some embodiments, the electrical connection may be formed through contacts disposed on housing 14, the contacts being in electrical communication with respective magnets. In another embodiment, the magnets may protrude through respective housing such that they contact each other directly. In other embodiments, electrical connections may be formed through leads carried by the magnets, rather than the magnets themselves. A significant magnetic force is applied between the components to retain the components in the desired configuration. The magnets of connectors 100 are mounted such that they are free to move under the magnetic forces present from an adjacent magnet and thereby provide the requisite magnetic field strength to retain the components in that configuration.

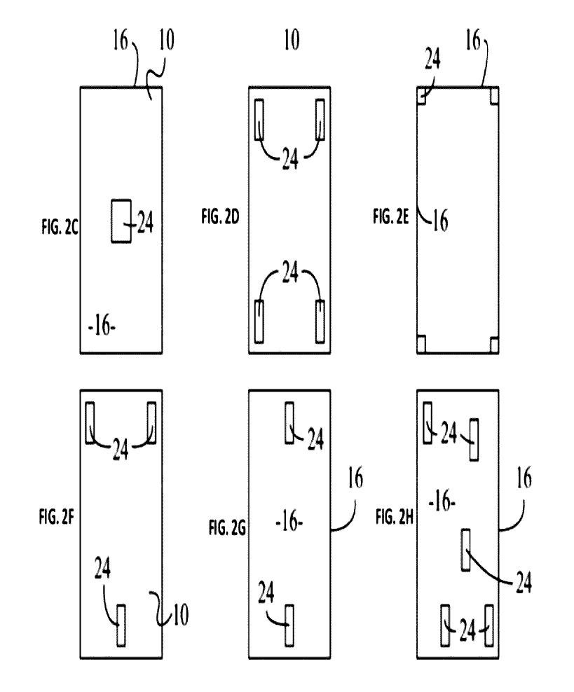

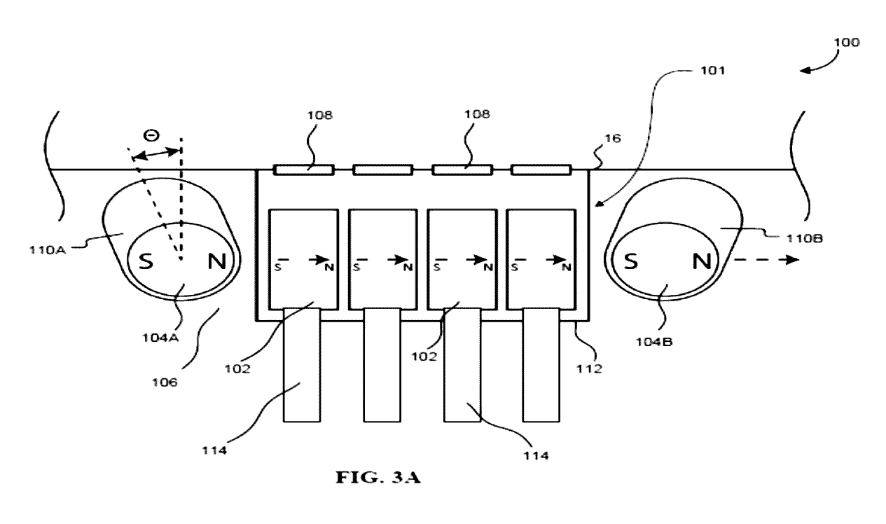

FIG. 2A illustrates a schematic view of device 10 in greater detail. As noted, device 10 is a smartphone. However, the disclosure herein is applicable to other types of electronic devices, such as a tablet computers, laptop computers, desktop computers, workstations, servers, portable computers, personal digital assistants, interactive televisions, video display terminals, gaming consoles, electronic reading devices, any other portable electronic device, or a combination of these. Device 10 may be integrated with a household appliance (e.g., a fridge, oven, washing machine, stereo, exercise bike, alarm clock, or the like), or a vehicle (e.g., on a vehicle dashboard). Further examples of magnetic connectors for connecting devices, and examples of devices incorporating such connectors are also described in application No. U.S. 62/257,138, PCT/CA2014/000803, and U.S. Ser. No. 14/918,177. These applications are incorporated herein by reference in their entirety.

Device 10 has a housing 14 defining front and rear surfaces and peripheral surfaces 16. Device 10 includes at least one internal circuit 20 which provides certain functions of device 10. For example, as illustrated in FIG. 2B, internal circuit 20 may include a processor 21, an input/output (I/O) interface 23, a network interface such as a Wi-Fi or cellular radio 25, memory 27, and a power delivery circuit (not illustrated) for receiving power from an external input and converting or conditioning it for delivery to other components of device 10. Components of internal circuit 20 may be formed on a single semiconductor die such as a system-on-chip, or as a plurality of components formed on separate semiconductor chips, mounted to a printed circuit board.

Processor 21 may be any type of processor, such as, for example, any type of general-purpose microprocessor or microcontroller (e.g., an ARM™, Intel™ x86, PowerPC™ processor or the like), a digital signal processing (DSP) processor, an integrated circuit, a programmable read-only memory (PROM), or any combination thereof. Memory 27 may include a suitable combination of any type of electronic memory that is located either internally or externally such as, for example, random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), or the like.

I/O interface 23 enables device 10 to communicate through connectors 100, e.g., to interconnect with other devices. I/O interface 23 also enables device 10 to interconnect with various input and output peripheral devices. As such, device 10 may include one or more input devices, such as a keyboard, mouse, camera, touch screen and a microphone, and may also include one or more output devices such as a display screen and a speaker. Network interface 25 enables device 10 to communicate with other devices (e.g., other devices) using a network.

Device 10 may be adapted to operate in concert with one or more interconnected devices. Device 10 may store software code in memory 27 and execute that software code at processor 21 to adapt it to operate in concert with one or more interconnected devices. The software code may be implemented in a high level procedural or object oriented programming or scripting language, or a combination thereof. The software code may also be implemented in assembly or machine language.

As noted, device 10 also includes a plurality of connectors 100 for connecting device 10 to external devices. Each connector 100 can connect device 10 with, for example, smartphones, speakers, power supplies input/output peripherals or the like. Connectors 100 may be connected to one or more components of internal circuit 20 for data or power transmission. In some embodiments, connectors 100 may for example provide universal serial bus (USB) connections to external devices. Device 10 may act as a host or client device using such connection.

For enhanced flexibility, a connector 100 at each corner of the housing 14, as illustrated in FIG. 2A, is preferred. However, in different devices, it may not be necessary to provide a connector in each corner, but rather distribute the connectors about the housing at convenient locations. FIGS. 2C-2H illustrate, non-exhaustively, a variety of locations. Thus, connectors 24 may be located centrally, as illustrated in FIG. 2C, inset from each corner as illustrated in FIG. 2D or at the corners as described above and illustrated in FIG. 2E. It is also possible to arrange the connectors 24 so that only a preferred orientation is available, for example by arranging the connectors 24 at the apexes of a triangle as illustrated in FIG. 2F, or only selected areas of the housing 14 as illustrated in FIG. 2H. A flexible orientation can be provided by arranging the connectors 24 along a major axis of the housing 14 as illustrated in FIG. 2G so that the connection is attained in either of two positions. As noted above, in some embodiments, the magnets may be utilized to connect the devices both mechanically and electrically.

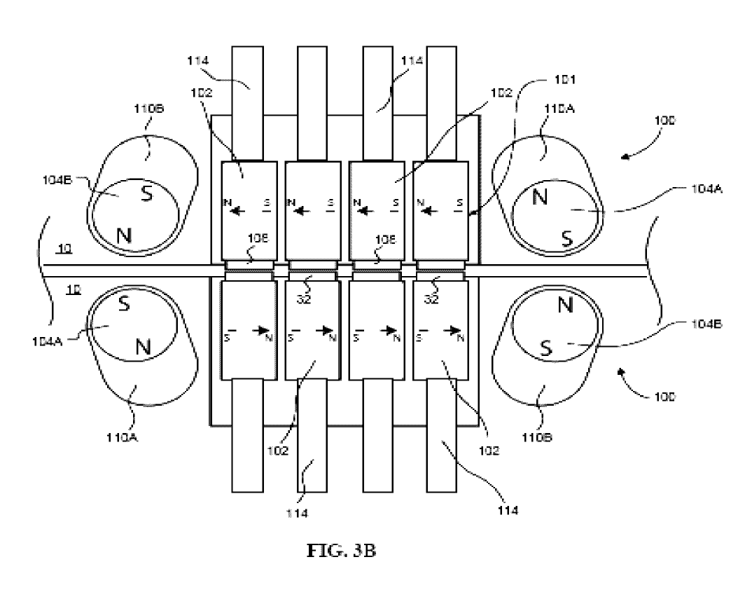

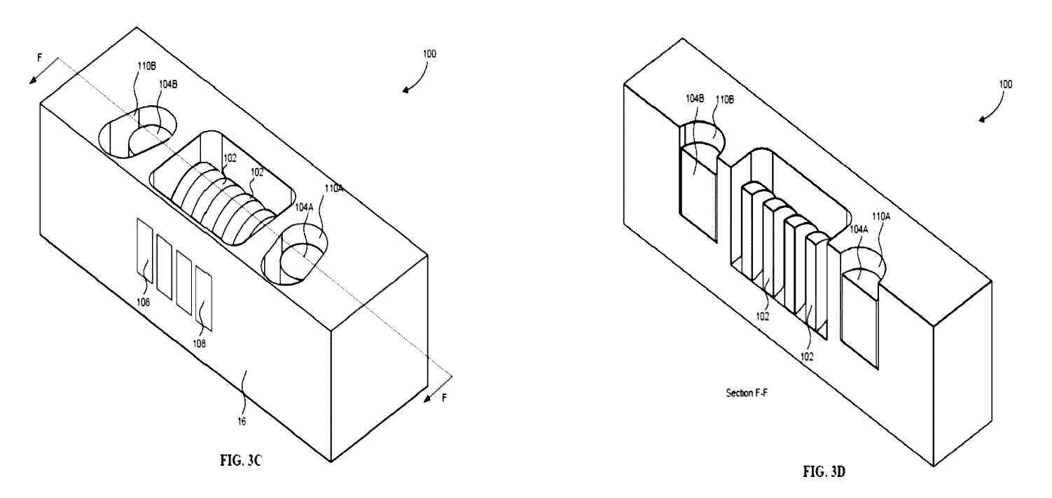

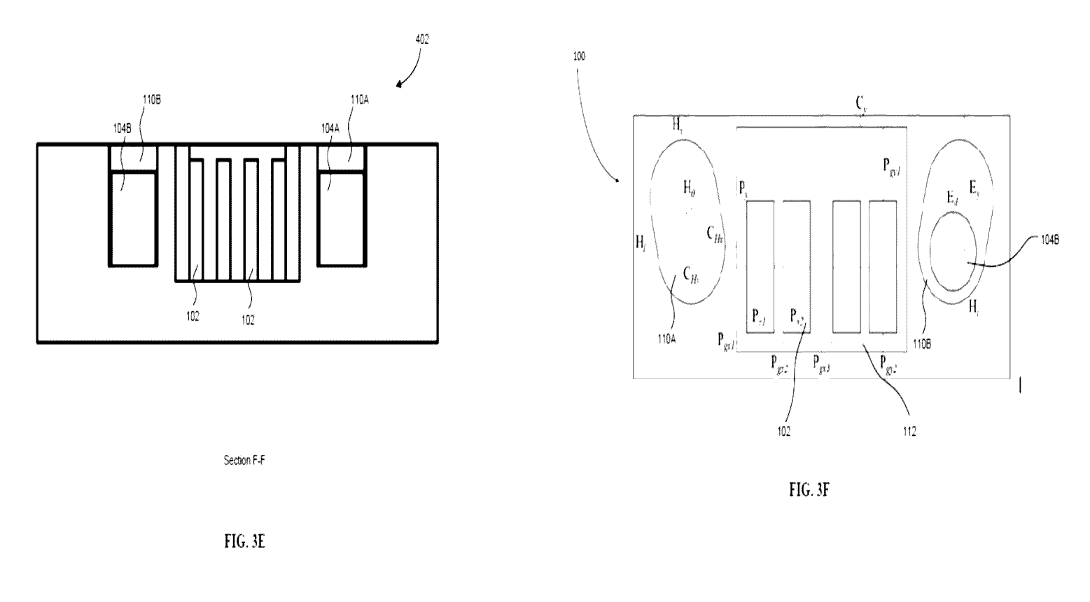

An example connector 100 is illustrated in top view in FIG. 3A, with a top housing surface omitted for purposes of illustration. This example arrangement includes a magnetic contact assembly 101 with four magnets 102 (which may be referred to as “core magnets”), received in a connector housing 106 and movable in a path defined by a guide, such as a channel 112. Connector 100 further includes two side magnets 104A and 104B disposed within connector housing 106. Housing 106 may be formed from suitable materials that are insulating and may be readily shaped, such as, e.g., polybutylene terephthalate (“PBT”), polyethylene terephthalate (“PET”), or the like. Housing 106 may be integral with device housing 14 or may be a separate component received within housing 14. Some embodiments described herein include a discrete connector housing (e.g., housing 106). In other embodiments, the connector housing (e.g., housing 106) is integral with the device housing (e.g., housing 14). These possibilities are interchangeable. Accordingly, references to a device housing (e.g., housing 14) could be replaced with a discrete connector housing (e.g., housing 106) and vice-versa. A plurality of external electrical terminals 108 are disposed on the surface 16 of housing 106 for contacting corresponding contacts of another connector in electrical communication. External electrical terminals 108 may be formed from any suitable electrically conductive (e.g., metallic) material.

A plurality of leads 114 are electrically connected to magnets 102. As illustrated in FIG. 2A, each internal contact corresponds to an external terminal 108 and is electrically connected to one or more components of internal circuit 20. For example, one or more leads 114 may be connected to I/O interface 25 for data communication and one or more leads 114 may be connected to a power delivery circuit for power transmission. Magnetic contact assembly 101 includes magnets 102 and leads 114 and may also include insulating elements (not illustrated), for example, nylon spacers, between magnets 102 to electrically insulate magnets 102 from one another. Thus, leads 114 and magnets 102 may carry different signals.

Magnetic contact assembly 101 is contained in a channel 112 formed in housing 106. Channel 112 acts as a guide. Magnetic contact assembly 101 is slidable along a path defined by channel 112 between a withdrawn position in which magnets 102 are spaced inwardly from surface 16, as illustrated in FIG. 3A, and an extended position, in which magnets 102 abut terminals 108 to form an electrical connection between terminals 108 and the respective leads 114. As illustrated in FIG. 3A, magnets 102 share a common orientation, namely, an orientation that provides a north-south alignment parallel to surface 16, indicated in FIG. 3A by arrows marked S-N. In such orientation, the north pole of one magnet 102 is adjacent the south pole of an adjacent magnet 102. Further, in such orientation, each magnet 102 presents both north and south poles to a terminal 108.

Side magnets 104A and 104B are disposed in channels 110A and 110B, respectively. Channels 110A and 110B are formed in housing 106 of connector 100 on right and left sides of core magnets 102, respectively. Channels 110A and 110B act as guides and define paths which extend inwardly away from surface 16 and converge towards one another and toward channel 112. As illustrated, channel 110A is oriented at an angle away from the normal line of surface 16 while channel 110B is oriented at an opposite angle. Each of channels 110A and 110B has a first end proximate surface 16 and a second end farther away from surface 16 and closer to channel 112 and thus, magnetic contact assembly 101. Each of channels 110A and 110B is formed such that each of magnets 104A and 104B may slideably move along a path defined by its respective channel 110A or 110B between an extended position at the first end and a withdrawn position at the second end, i.e., to be closer or farther from surface 16.

Furthermore, channels 110A and 110B and side magnets 104A and 104B are shaped such that each side magnet 104A and 104B may rotate within its respective channel. Each of magnets 104A and 104B may rotate between a first orientation in which the magnets 104A and 104B are oriented with a north-south alignment parallel to surface 16 and a second orientation in which the magnets 104A and 104B are oriented with a north-south alignment diagonal relative to surface 16.

In the illustrated embodiment, each of side magnets 104A and 104B has a cylindrical shape, and the channels 110A and 110B are formed to allow each side magnet to rotate about its cylindrical axis. In other embodiments, each of side magnets 104A and 104B may have a different shape allowing each to rotate between the noted first and second orientations. For example, each of side magnets 104A and 104B may have a spherical shape, a hemispherical shape, an ovoid shape, etc.

FIG. 3A shows side magnets 104A and 104B each positioned at the second end of the respective channel 110A or 110B, retracted from surface 16. Magnetic contact assembly 101 is also in a position retracted from surface 16 (and terminals 108). Magnets 102, 104A, and 104B assume the illustrated positions when the connector 402 is not engaged with a complementary connector 402, which may be referred to as a “resting” state, a “retracted”, or a “disengaged” state of the connector 402.

Magnets 102, 104A, and 104B are drawn towards the illustrated positions because of mutual attraction between magnets 102, 104A, and 104B. Mutual attraction between magnets 102, 104A, and 104B causes side magnets 104A and 104B to move along a respective channel 110A or 110B towards magnets 102 and towards one another. As side magnets 110A and 110B move towards magnets 102, the angle of the channel 110A or 110B causes the side magnets to move away from surface 16. The mutual attraction between magnets 102, 104A, and 104B also draws magnets 102 away from surface 16. Further, this mutual attraction causes side magnets 104A and 104B to rotate such that they have the same north-south alignment as magnets 102, i.e., parallel to surface 16.

In this way, mutual attraction between magnets 102 of magnetic contact assembly 101 and side magnets 104A and 104B biases each of the magnets towards a retracted position away from surface 16. Conveniently, no mechanical biasing is required. With magnets 102, 104A, and 104B in their retracted positions, connector 100 is in a disengaged state and terminals 108 are not electrically connected to the internal connectors or to the internal device circuit. Further, when connector 100 is in the disengaged state and magnets 102, 104A, and 104B are retracted from surface 16, magnetic flux at surface 16 may be significantly reduced. Conversely, connector 100 may be drawn into an engaged state, in which magnets 102, 104A, and 104B are in their respective extended positions, by an adjacent connector.

FIG. 3B shows two connectors 100 with the arrangement illustrated in FIG. 3A. As illustrated, the two connectors 100 are engaged, such that each connector 100 is in an engaged state. When in this state, terminals 108 and corresponding magnets 102 of the two connectors 100 may form electrical connections between two devices 10 for power or data transmission. In one specific example, each pair of corresponding magnets 102 of the two connectors 100 may form a connection for a USB pin/wire, e.g., VCC, D−, D+, GND. Thus, a USB connection may be provided. In other embodiments, connector 100 may have a fewer or greater number of magnets 102 to support a greater number of pins/wires. Connections other than USB (e.g., Firewire) may also be provided.

As illustrated, in the engaged state, side magnets 104A and 104B are positioned in their extended positions at the first end of a respective channel 110A or 110B, proximate surface 16. Side magnets 104A and 104B of a first device 10 are drawn to the first end, by sliding movement along a respective channel 110A or 110B, because of attraction between the side magnets 104A and 104B and corresponding side magnets 104A and 104B of a second device 10. So, when the connectors 100 of the two devices 10 are engaged side magnet 104A of the first device 10 is aligned with and magnetically coupled with side magnet 104B of the second device 10. Similarly, side magnet 104B of the first device 10 is aligned with and magnetically coupled with side magnet 104A of the second device 10.

As side magnets 104A and 104B are drawn towards surface 16 along a respective channel 110A or 110B, the angle of the channel causes side magnets 104A and 104B to each move away from core magnets 102. Further, as side magnets 104A and 104B in the first device move along a respective channel 110A or 110B, mutual attraction between the side magnets 104A and 104B and the corresponding side magnets 104A and 104B in the second device causes each of the side magnets to rotate within its respective channel towards the second orientation noted above, in which the poles of magnets 104A and 104B are oriented diagonally to surface 16. Consequently, in each device 10, mutual attraction between magnets 102, 104A, and 104B decreases, and the bias of magnets 24 towards a retracted position is reduced. While magnets 104A and 104B are aligned with magnets 102 (as in the disengaged position), magnetic attraction between magnets 102, 104A, and 104B may be sufficiently strong that an adjacent magnet 102 of another connector cannot cause magnet 102 to move outwardly. However, rotation of side magnets 104A and 104B due to the presence of an adjacent magnet 104B or 104A reduces magnetic attraction between magnets 102, 104A, and 104B. Thus, such rotation releases magnets 102 from the inwardly-biased disengaged position; once magnets 104A and 104B are rotated toward their diagonal orientations, magnet 102 can be drawn outwardly toward the engaged position by an adjacent magnet 102 of another connector.

In each device 10, movement of side magnets 104A and 104B towards surface 16 draws magnets 102 towards the surface by magnetic attraction. Further, as magnets 102 of the first device move towards the surface, they become drawn by the corresponding magnets 102 in the second device 10, and vice versa. In this way, magnets 24, 104A, and 104B of each device 10 collectively move towards the engaged positions illustrated in FIG. 3B.

As noted, when the connectors 100 are engaged, each side magnet 104A and 104B may have a north-south alignment that is diagonal relative to surface 16. The attraction between a side magnet 104A or 104B of a device 10 and a complementary side magnet 104B or 104A of an engaged device 10 tends to cause each side magnet to rotate towards an orientation perpendicular to surface 16. Meanwhile, the attraction between a side magnet 104A or 104B and core magnets 102 in the same device tends to cause each side magnet 104A and 104B to rotate towards an orientation parallel to surface 16. Thus, when the connectors 100 are engaged, each side magnet 104A and 104B maintains a diagonal orientation. Thus, when engaged, magnets 104A and 104B pull devices 10 toward one another and magnetically hold the devices together. Each of channels 110A and 110B may be oriented at an angle (FIG. 3A) between 0 degrees and 90 degrees. In some embodiments, the angle may be between 0 degrees and 20 degrees. A larger angle causes side magnets 104A and 104B to move farther away from magnets 102 when a connector 100 transitions from a resting state to an engaged state.

Magnets 102, 104A, and 104B and channels 112, 110A, and 110B may be configured to ensure that, when two connectors 100 are placed in abutment as illustrated in FIG. 3B, attraction between magnets 102, 104A, and 104B of one connector 100 and the corresponding magnets 102, 104A, and 104B of the other connector 100 is sufficient to overcome the magnetic attraction between magnets 102, 104A, and 104B of a single connector biasing the connector to the disengaged state. In other words, the configuration of magnets 102, 104A, and 104B and channels 112, 110A, and 110B is such that two connectors 100 can overcome the magnetic bias toward the disengaged state to draw one another into the engaged state. For example, magnets 104A and 104B may be at least twice as far from one another as they are from device edge 16. Suitable sizes, orientations and spacing of channels 112, 110A, and 110B depends on the strengths of magnets 102, 104A, and 104B and will be apparent to skilled persons in the art based on the present disclosure. In an example, magnets 102, 104A, and 104B are neodymium-iron-boron (NdFeB) magnets. FIG. 3F illustrates an example connector 100, annotated with references to identify example dimensions. Corresponding example values of those dimensions are listed in Table 1.

TABLE 1

| Ed | Ht | Hy | Hθ | Ey | Hl | Px1 | Px2 | Py | Pgx1 | Pgx2 | Pgx3 | Pgy1 | Pgy2 | Cy | CHx | CHy |
|---|---|---|---|---|---|---|---|---|---|---|---|---|---|---|---|---|
| 5 | 0.2 | 0.25 | 11 | 2.95 | 3.62 | 1.5 | 1.5 | 8 | 1.59 | 1.6 | 1.6 | 2 | 0.5 | 0.5 | 1.6 | 0 |

FIG. 3C is a perspective view of a portion of device 10 including a connector 100 illustrated in FIG. 3A. For the sake of illustration, the top surface of this portion is illustrated as being cut away to reveal magnets 102, channels 110A or 110B, and side magnets 104A or 104B within. As illustrated in FIG. 3C, the connector 100 is in a disengaged state with magnets 102 and magnets 104A or 104B in their respective withdrawn positions retracted from surface 16.

As illustrated in FIG. 3C, each magnet 24 has a disk shape. However, in other embodiments, each magnet 102 may have a different shape. Furthermore, there may be a fewer or greater number of magnets 102. The arrangement of magnets 102 illustrated in FIG. 3C may be replaced with another arrangement of magnets, as described herein. Similarly, although four terminals 108 are illustrated, there may be a fewer or greater number of terminals. Though the connector of FIG. 3C has one magnet 102 corresponding to each terminal 108 other embodiments may have more than one terminal per magnet.

FIG. 3D is a perspective cross-sectional view of the connector 100 of FIG. 3C, taken along line F-F. FIG. 3E is a side cross-sectional view of the connector 100 of FIG. 3C, taken along line F-F. As illustrated in FIGS. 3D and 3E, channel 110A or 110B has a shape complementary to cylindrical side magnet 104A or 104B, allowing magnets 104A or 104B to slide and rotate within respective channels 110A or 110B in manners described herein.

In some embodiments, magnets 102 may be replaced with passive magnetic materials. For example, magnets 102 may be replaced with ferrous elements or other magnetizable elements. In such embodiments, movement of side magnets 104A and 104B to their engaged positions may magnetically draw contact assembly 101 to its engaged position.

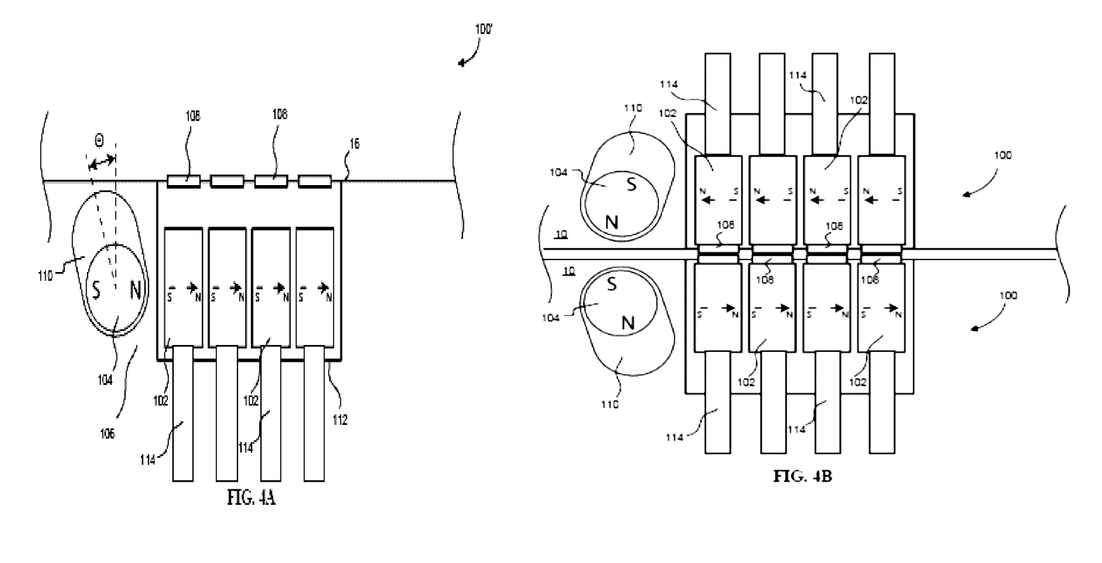

In some embodiments, connectors may have only one side magnet. For example, FIG. 4A illustrates a top view of one such connector 100′, which is identical to connector 100 except that it has only a single side magnet 104, received in a channel 110. FIG. 4B illustrates a top view of two connectors 100′ in an engaged state. Top housing surfaces are omitted in FIGS. 4A and 4B for purposes of illustration.

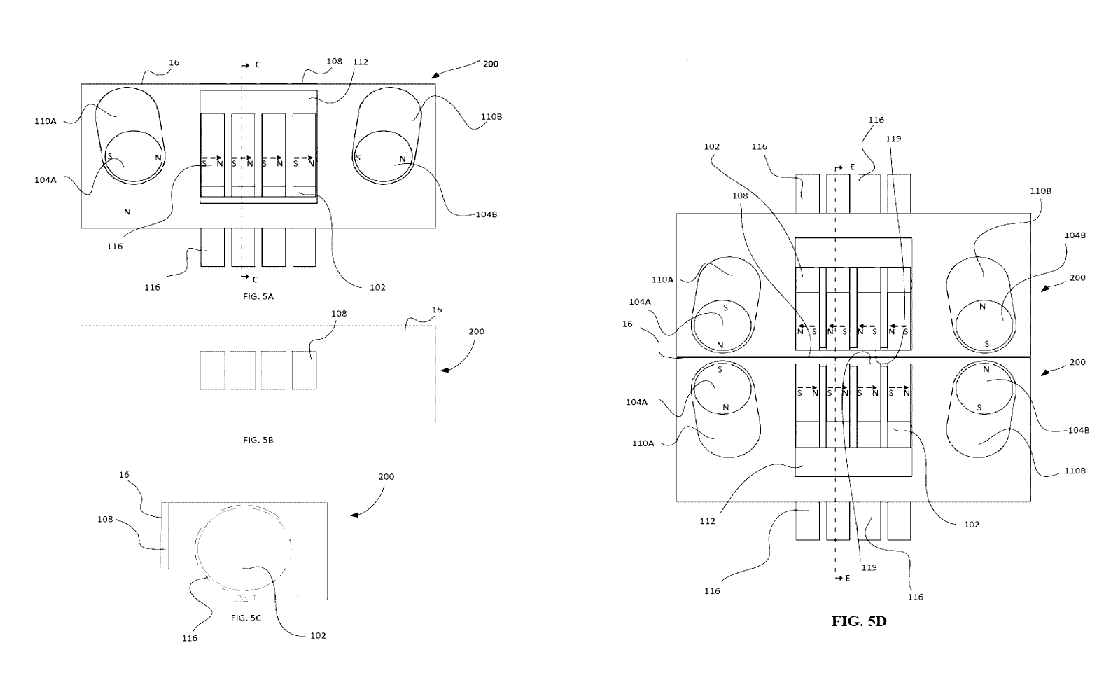

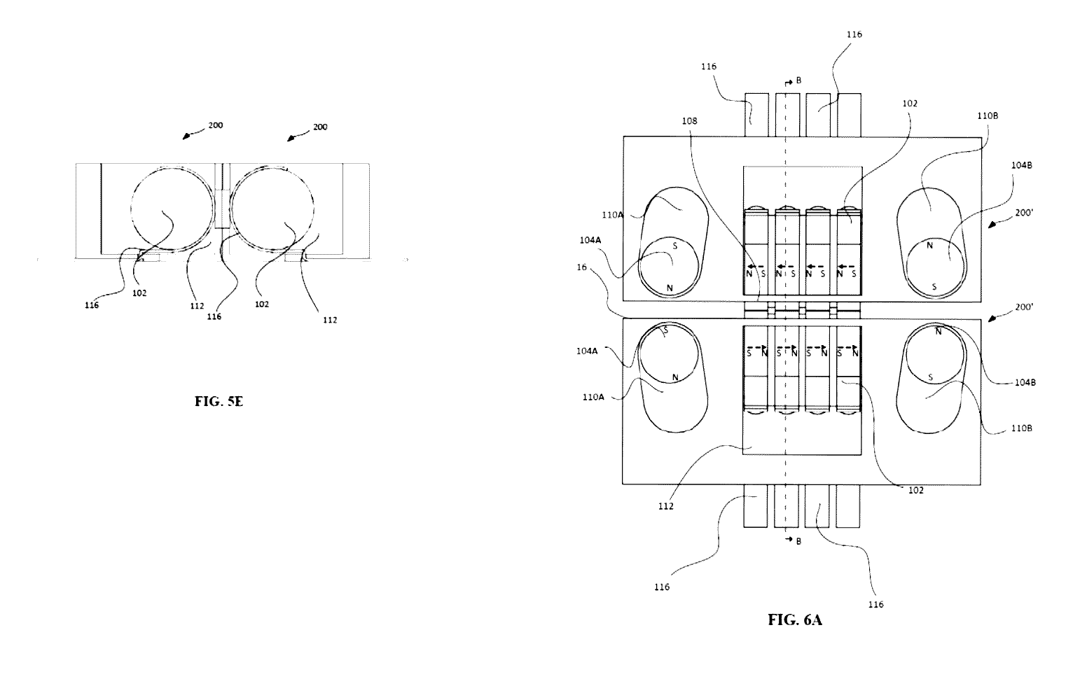

In some embodiments, the magnetic contact assembly may include leads on the outward-facing side of magnets 102. For example, FIGS. 5A and 5B illustrate top and front views, respectively of a connector 200 with a top housing surface omitted in FIG. 5A for purposes of illustration. FIG. 5C illustrates a side cross-sectional view of connector 200 along line C-C illustrated in FIG. 5A. Connector 200 is identical to connector 100 except as otherwise described, and like components are identified with like reference characters.

As illustrated in FIGS. 5A and 5C, connector 200 has a magnetic contact assembly 201 including leads 116. Each lead 116 is connected to internal circuit 20 of device 10. In an example, each lead 116 may correspond to a USB pin (e.g., VCC, D−, D+, GND) such that connector 200 may provide a USB connection.

Leads 116 are wrapped around magnets 102 such that portions of leads 116 are positioned on the outer side of magnets 102, facing contacts 108. Leads 116 may be electrically insulated from magnets 102, for example, by an insulative sleeve or coating applied to one or both of leads 116 and magnets 102. In such embodiments, insulation between magnets 102 may be omitted. Alternatively, leads 116 may electrically contact magnets 102, in which case magnets 102 may be insulated from one another to isolate signals on different leads 116. Leads 116 may be formed from a ferrous material and of sufficient conductivity to allow for high speed data transfer. Their thickness may be sufficiently low to allow for high flexibility.

Leads 116 may magnetically adhere to the adjacent core magnets 102. Leads 116 may, for example, be coiled around magnets 102 and held against magnets 102 by magnetic attraction. As magnets 102 move, the coiled leads 116 may change in shape slightly. For example, when magnets 102 move inwardly, the coil may tighten as magnetic attraction holds leads 116 tightly to magnets 102. Conversely, when magnet 102 moves outwardly, the coil may stretch.

FIGS. 5D and 5E illustrate top and side cross-sectional views, respectively, of a pair of Connectors 200 in their engaged states, the latter taken at line E-E of FIG. 5D. Top housing surfaces are omitted in FIG. 5D for purposes of illustration. As illustrated in FIG. 5E, in the engaged state, magnets 102 urge leads 116 outwardly against contacts 108. Thus, an electrical connection may be formed through lead 116 and an associated contact 108 of one connector 200, and a corresponding lead 116 and contact 108 of another connector. As noted, the electrical connection may be used for power or data transmission.

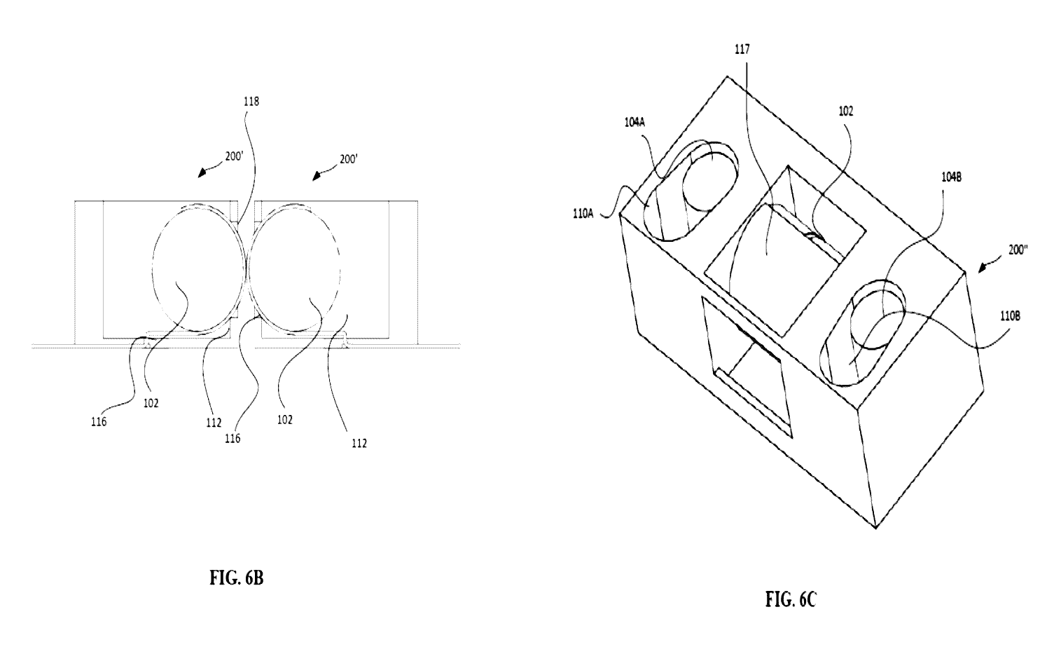

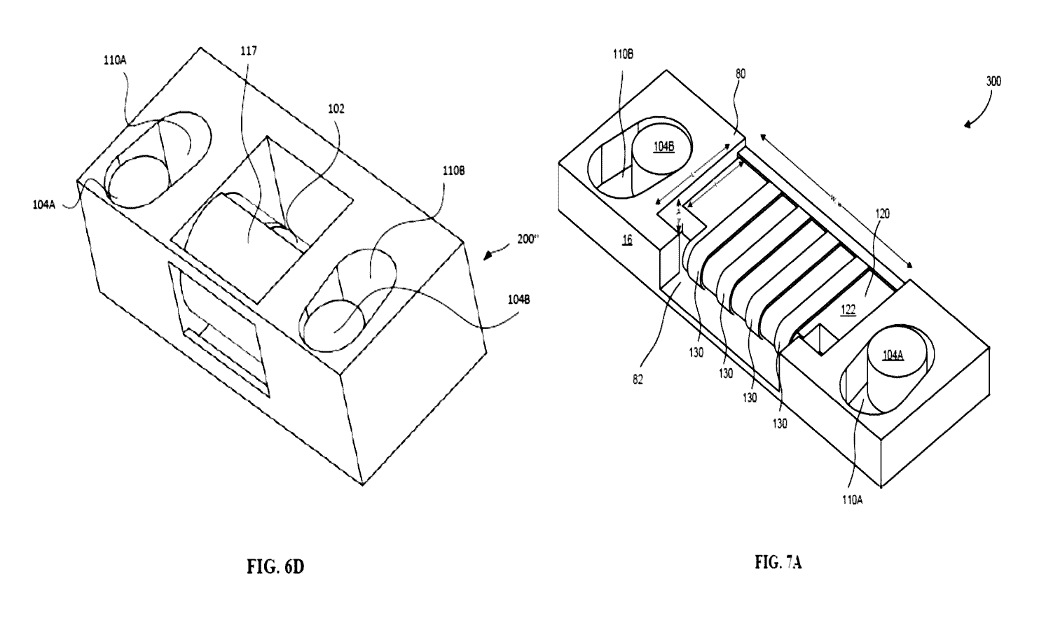

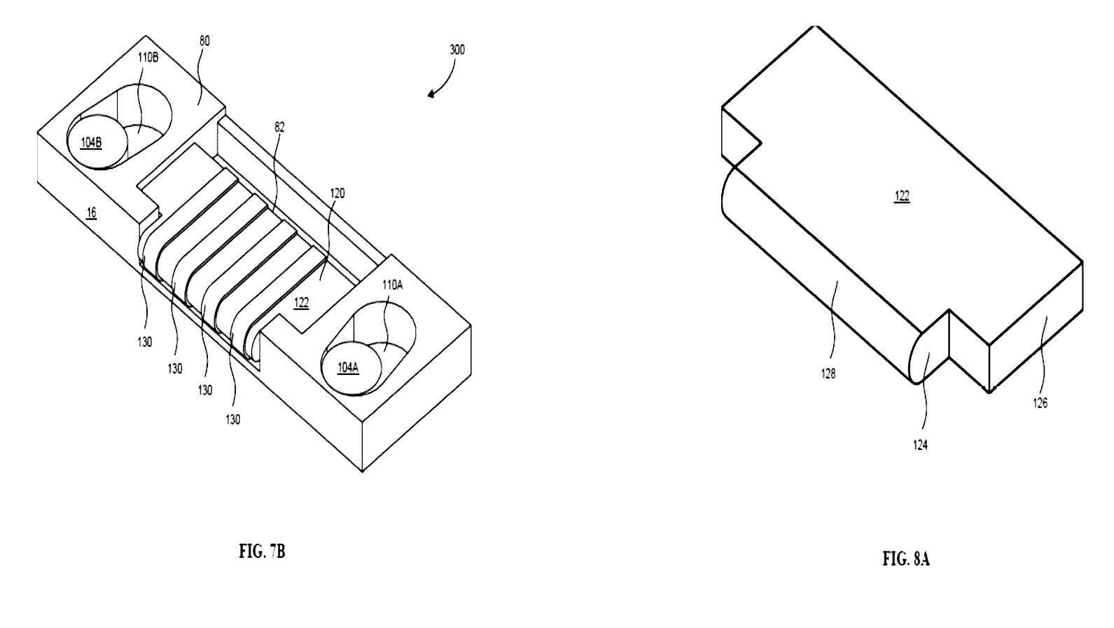

In some embodiments, contacts 108 may be omitted, such that magnets 102 or leads 116 protrude from housing 14 in the engaged state. FIGS. 6A and 6B show two connectors 200′ exemplary of such an embodiment, the latter view taken along line B-B of FIG. 6A in top and side cross-section views, respectively, the latter taken at line B-B of FIG. 6A. Top housing surfaces are omitted in FIG. 6A for purposes of illustration. Connectors 200′ are identical to connectors 200 except as otherwise described and like components are indicated with like numerals.

As illustrated in FIG. 6B, connectors 200′ lack contacts 108. Instead, connectors 200′ have openings 118 through which magnets 102, leads 116 protrude in the engaged state. Thus, in the engaged state, electrical connections are directly formed between leads 116 of the two connectors 200′.

In some embodiments, leads 116 may be bonded to core magnets 102, for example, using adhesives. Leads 116 may be bonded to a flexible substrate, constraining and insulating the individual traces. For example, FIGS. 6C and 6D illustrate perspective views of connectors 200″ in disengaged and engaged states, respectively, in which leads 116 are incorporated in a conventional flat flexible cable (“FFC”) 117, which may be bonded to magnets 102. Bonding of leads 116 to a substrate may allow for tighter pitch between leads 116 relative to individually attaching leads 116 to magnets 102.

In other embodiments, magnets 102 of two connectors may directly contact one another, rather than leads 116, an electrical connection may be formed between magnets 102.

In each of connectors 100, 200, and 200′, magnets 102 are disc-shaped. In other embodiments, magnets may be provided in different shapes. For example, magnets 102 may be replaced with bar magnets. In addition, in each of connectors 200 and 200′, each magnet 102 is associated with one lead 116. In other embodiments, magnets 102 may be associated with multiple leads. For example, magnets 102 may be replaced with a single bar magnet, which may be associated with any number of leads.

As illustrated, magnets 102 are oriented with their poles aligned generally parallel to peripheral surface 16. Likewise, magnets 102 present to one another contacting surfaces 119 (as illustrated in FIG. 5D) that are parallel to the north-south alignment of the magnets. In such an arrangement, attractive magnetic forces between opposing magnets 102 may be greatest at the edges of the contacting faces. In other words, magnetic flux may be greatest proximate the edges. Accordingly, in an example, two leads may be associated with each magnet 102, each lead being aligned proximate an edge of the contacting surface 119 of the magnet 102, near the maximum magnetic attractive force. Such a configuration may promote strong electrical connection between corresponding leads. In other embodiments, magnets 102 may be oriented with their north-south poles perpendicular to surface 16 and to the contacting surfaces magnets 102 present to one another.

FIGS. 7A and 7B illustrate a perspective view of a connector 300 with top housing surfaces omitted for purposes of illustration. FIG. 7A illustrates connector 300 in a disengaged (retracted or resting) state and FIG. 7B illustrates connector 300 in an engaged (extended) state. In some embodiments, the shaping of components within connector 300 allows connector 300 to be formed to be substantially thinner (e.g., having a lower profile) than connector 100.

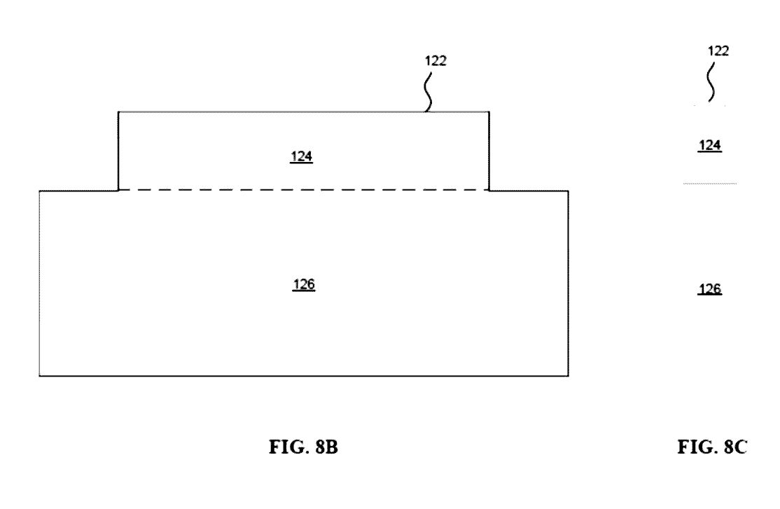

Unlike connector 200 which includes four core magnets 102 disposed within a housing, connector 300 includes a magnetic contact assembly 120 with a single magnet 122. FIGS. 8A-8C illustrate perspective, top elevation, and side elevation views, respectively, of magnet 122.

Assembly 120 is disposed within a connector housing 80. As detailed below, assembly 120 may move (e.g., slide) within housing 80 as connector 300 transitions between its disengaged and engaged states. In FIGS. 7A and 7B, the top surface of housing 80 is not illustrated for clarity of illustration.

Assembly 120 includes a single magnet 122. As illustrated in FIGS. 8A, 8B, and 8C, magnet 122 is T-shaped, and includes a crossbar portion 126 and a stem portion 124. Crossbar portion 126 is substantially rectangular. Stem portion 124 has approximately the same height as crossbar portion 126, but is smaller in width and length. Stem portion 124 has a rounded end 128, in the shape of a semi-cylinder. During operation, end 128 of stem portion 124 may form an opening in surface 16 of housing 80 (FIG. 7B). In this way, stem portion 124 may engage another connector (e.g., another connector 300) to form magnetic and electrical connections therewith, or to form a connection with a metal surface.

The rounded shape of end 128 allows two connected connectors to be rotated relative to one another without interrupting the mechanical or electrical connections. This rounded shape also provides points of contact between two connected connectors along a single line, thereby localizing contact forces to this line. Assembly 120 also includes a plurality of conductive wires 130. Each wire 130 may carry a separate electrical signal (data or power). In one specific example, each wire 130 may correspond to a USB pin (e.g., VCC, D−, D+, GND) such that connector 300 may provide a USB connection.

The plurality of conductive wires 130 are electrically isolated. As illustrated, the wires are spaced from one another. Further, to prevent conduction through magnet 122, each wire 130 may include an insulating backing material. Alternatively, or additionally, magnet 122 may be coated with an insulating material such as enamel, plastic, or the like. In the illustrated embodiment, assembly 120 includes four wires 130. However, in other embodiments, assembly 120 may include a fewer or greater number of wires 130. Further, connections other than USB (e.g., Firewire) may be provided. In the illustrated embodiment, each wire 130 extends over the coated surface of magnet 122 along the length of assembly 120 and wraps around rounded end 128. In this way, the part of wire 130 extending over end 128 may contact parts (e.g., wires/pins) of another connector for establishing electrical connections therewith.

In another embodiment, channels may be formed on the surface of magnet 122 and wires 130 may be received in and may extend along these channels. The channels may have a depth corresponding to the thickness of wires 130. Accordingly, when wires 130 are received in the channels, the top surface of the wires 130 may be flush with the top surface of magnet 122. This allows, for example, electrical connection between wires 130 and contacts pressed to the top surface of magnet 122. Conveniently, providing these channels may allow the overall height of assembly 120 to be reduced in some embodiments.

Referring now to FIGS. 7A and 7B, housing 80 may be formed from suitable materials that are insulating and may be readily shaped, such as PBT, PET, or the like. Housing 80 includes a cavity 82 having a height (H) and width (W) sized to correspond to the height (h) and width (w) of assembly 120. Cavity 82 has a length (L) greater than the length (1) of assembly 120. Accordingly, assembly 120 may move within cavity 82 along length (L) between a first position in which assembly 120 is adjacent a back wall of housing 80 (when connector 300 is in its disengaged state) and a second position in which assembly 120 is adjacent a front wall of housing 80 when connector 300 is in its engaged state. In the second position, stem portion 124 extends through an opening in the front wall (e.g., to connect with another connector, a metal surface, etc.).

Connector 300 also includes two side magnets 104A and 104B disposed, respectively, in channels 110A and 110B. Magnets 104A or 104B and channels 110A or 110B are provided in connector 300 to be substantially like the same components in connectors 100 and 200. Further, magnets 104A and 104B interact with assembly 120 in connector 300 in substantially the same manner that magnets 104A and 104B interact with core magnets 102 in connectors 100 and 200.

Channels 110A and 110B are formed in connector 300 on right and left sides of assembly 120, respectively. Channel 110A is oriented at an angle (as illustrated in FIG. 3A) away from the normal line of surface 16 while channel 110B is oriented at an opposite angle. Each of channels 110A and 110B has a first end proximate surface 16 and a second end farther away from surface 16. Each of channels 110A and 110B is formed such that magnets 104A and 104B may slideably move within its respective channel between the first end and the second end, i.e., to be closer or farther from surface 16.

Further, channels 110A and 110B and side magnets 104A and 104B are shaped such that each side magnet may rotate within its respective channel. In one example, assembly 120 may have a magnetic orientation as illustrated for magnets 102 in FIG. 3A, namely, with a north-south alignment parallel to surface 16 and north being in the direction of channel 110B. In this example, each of magnets 104A and 104B may rotate between a first orientation in which the magnets are oriented with a north-south alignment parallel to surface 16 (e.g., as illustrated in FIG. 3A) and a second orientation in which the magnets are oriented with a north-south alignment diagonal relative to surface 16 (e.g., as illustrated in FIG. 3B).

In the illustrated embodiment, each of side magnets 104A and 104B has a cylindrical shape and channels 110A and 110B are formed to allow each of side magnets 104A and 104B to rotate about its cylindrical axis. In other embodiments, each of side magnets 104A and 104B may have a different shape allowing each to rotate between the noted first and second orientations. For example, each of side magnets 104A and 104B may have a spherical shape, a hemispherical shape, an ovoid shape, etc.

FIG. 7A shows side magnets 104A and 104B each positioned at the second end of the respective channel 110A or 110B retracted from surface 16. Assembly 120 is also in a position retracted from surface 16 and adjacent a back wall of housing 80. Assembly 120 and side magnets 104A and 104B assume the illustrated positions when the connector 300 is in its disengaged state.

Assembly 120 and side magnets 104A and 104B are drawn towards the illustrated positions because of mutual attraction between assembly 120 and magnets 104A and 104B. Mutual attraction between assembly 120 and side magnets 104A and 104B causes side magnets 104A and 104B to move along a respective channel 110A or 110B towards assembly 120. As side magnets 104A and 104B move towards assembly 120, the angle of their respective channels 110A and 110B causes the side magnets to move away from surface 16. The mutual attraction between assembly 120 and side magnets 104A and 104B also draws assembly 120 away from surface 16. Further, this mutual attraction causes side magnets 104A and 104B to rotate such that they have the same north-south alignment as assembly 120, i.e., parallel to surface 16.

In this way, mutual attraction between assembly 120 and side magnets 104A and 104B biases them towards a retracted position away from surface 16. Conveniently, no mechanical biasing is required. Further, when connector 300 is in its disengaged state and assembly 120 and magnets 104A and 104B are retracted from surface 16, magnetic flux at surface 16 may be significantly reduced.

FIG. 7B shows connector 300 with side magnets 104A and 104B each positioned at the first end of the respective channel 110A or 110B, i.e., proximate surface 16. At the same time, assembly 120 is a position proximate surface 16 such that stem portion 124 extends past surface 16. Assembly 120 and side magnets 104A and 104B assume the illustrated positions when the connector 300 is in its engaged state.

Side magnets 104A and 104B of the connector 300 (which may be referred to as the first connector 300) are drawn to the first end of the respective channel 110A or 110B by sliding movement along a respective channel 110A or 110B because of attraction between the side magnets 104A and 104B and corresponding side magnets 104A and 104B of a second connector 300 (not illustrated).

As side magnets 104A and 104B are drawn towards surface 16 along a respective channel 110A or 110B the angle of the channel causes side magnets 104A and 104B to each move away from assembly 120. Further, as side magnets 104A and 104B in the first connector 300 move along a respective channel 110A or 110B, mutual attraction between the side magnets 104A and 104B in the first connector 300 and the corresponding side magnets 104A and 104B in the second connector 300 causes each of the side magnets 104A or 104B to rotate within its respective channel towards the second orientation noted above. Consequently, in each connector 300 mutual attraction between assembly 120 and side magnets 104A and 104B decreases and biasing towards a retracted position is reduced.

In each connector 300, movement of side magnets 104A and 104B towards surface 16 draws assembly 120 towards surface 16. Further, as the assembly 120 of the first connector 300 moves towards surface 16, it becomes drawn by the assembly 120 of the second connector 300, and vice versa. In this way, assemblies 120 and side magnets 104A and 104B of the first and second connectors 300 collectively move towards the engaged position.

When the two connectors 300 are engaged, side magnet 104A of the first connector 300 is aligned with and magnetically coupled with side magnet 104B of a second connector 300 (in substantially the same manner as illustrated in FIG. 3B for connectors 100). Similarly, side magnet 104B of the first connector 300 is aligned with and magnetically coupled with side magnet 104A of the second connector 300.

When two connectors 300 are engaged, each side magnet 104A and 104B may have a north-south alignment that is diagonal relative to surface 16 (e.g., as illustrated in FIG. 3B). Each of channels 110A and 110B may be oriented at an angle (e.g., as illustrated in FIG. 3A) between 0 degrees and 90 degrees. In some embodiments, the angle may be between 0 degrees and 20 degrees. A larger angle causes side magnets 104A and 104B to move farther away from assembly 120 when a connector 300 transitions from a resting state to an engaged state.

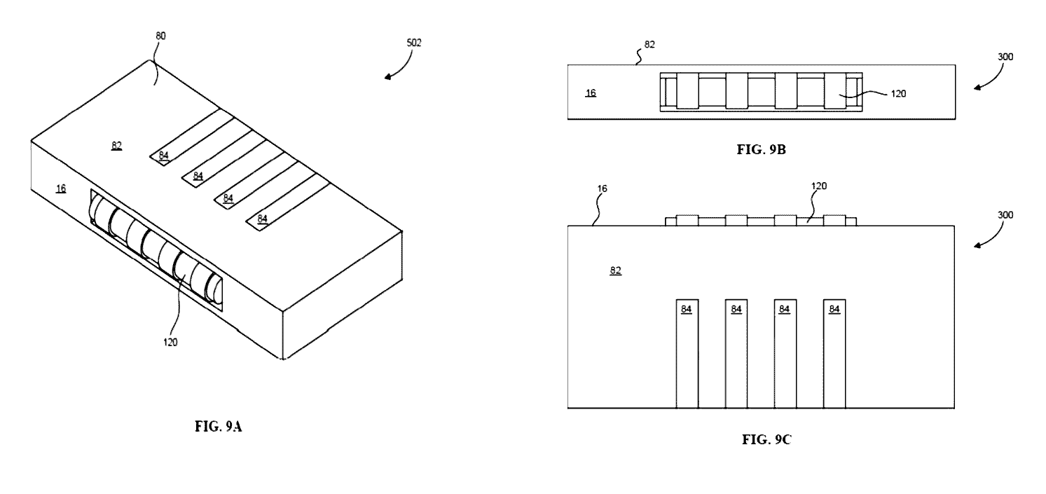

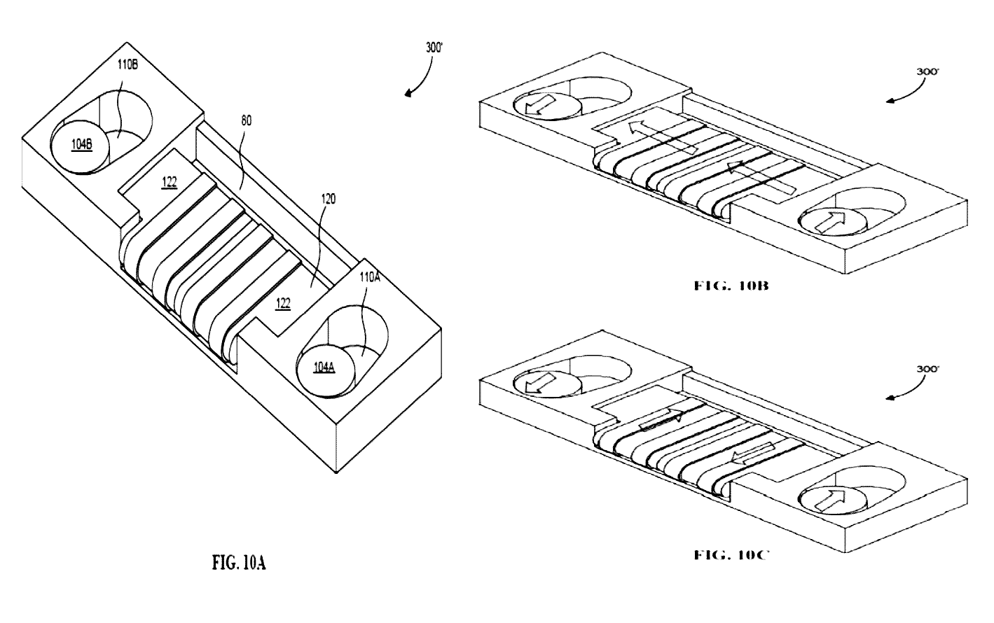

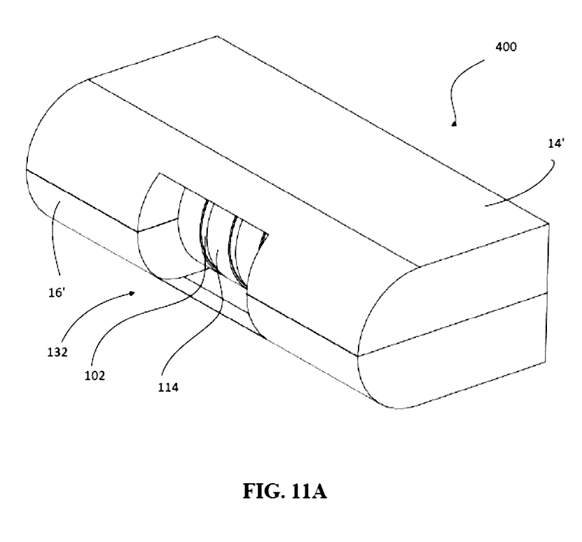

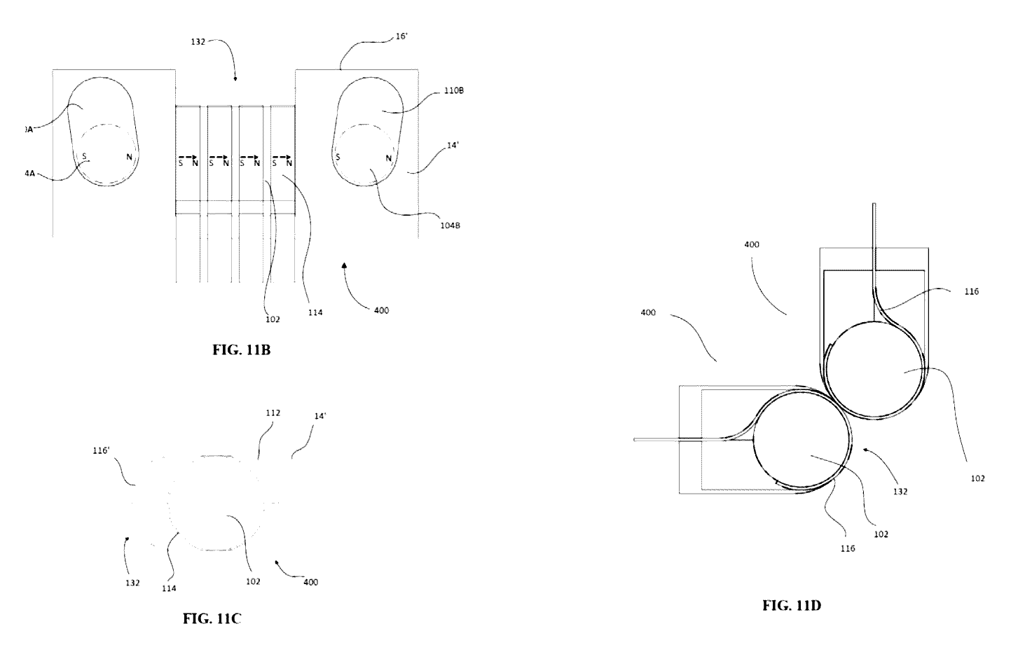

FIGS. 9A, 9B, and 9C are, respectively, a perspective view, a front view, and a top view of connector 300 with a top surface 82 of housing 80 illustrated. Connector 300 is illustrated to be in its engaged state such that assembly 120 extends out of housing 80 (as illustrated in FIG. 9C). As illustrated, top surface 82 includes a plurality of electrical contacts 84, each in electrical communication with a corresponding wire 130 of assembly 120. Electrical contacts 84 allow electrical signals carried by wires 130 to be provided to internal circuitry of a device in which connector 300 is disposed. For example, electrical contacts 84 may serve as solder points for connection of electrical wiring (not illustrated).

In the embodiment of FIGS. 7A and 7B, assembly 120 is formed from a single core magnet 122. However, in other embodiments, assembly 120 may be formed from multiple core magnets 122. For example, FIG. 10A shows a connector 300′ having an assembly 120 formed from two core magnets 122. The core magnets 24 may have the same magnetic orientation (e.g., as illustrated in FIG. 10B) or different magnetic orientations (e.g., as illustrated in FIG. 10C). Top housing surfaces are omitted in FIGS. 10A-10C for purposes of illustration.

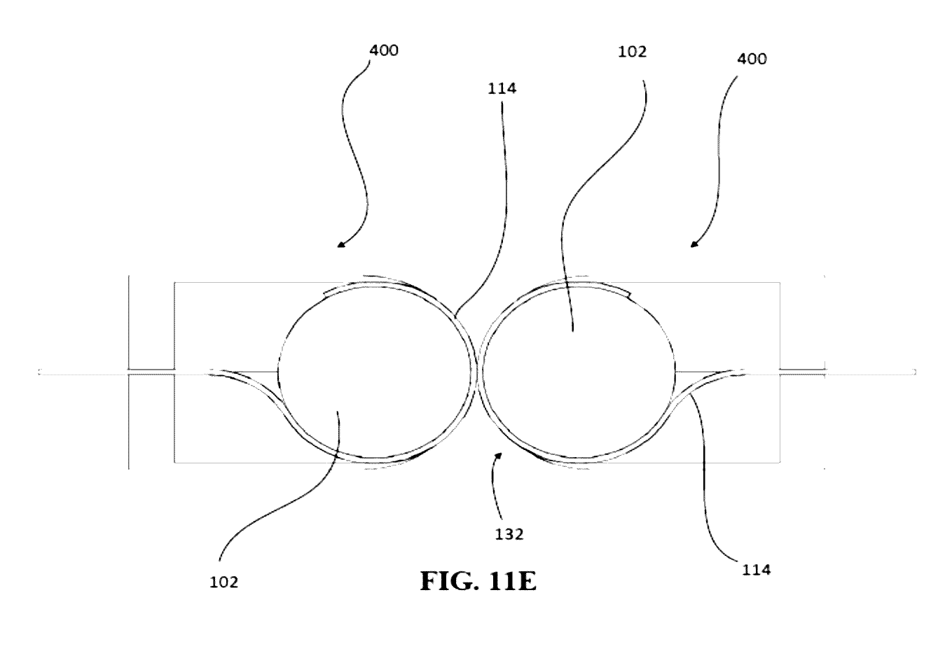

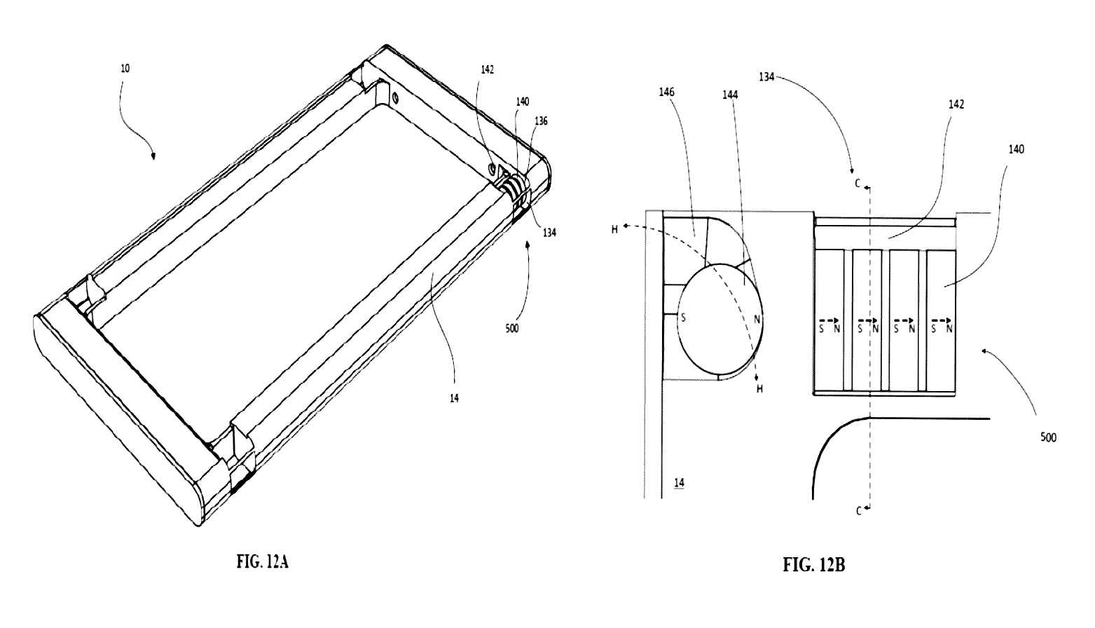

As illustrated in FIGS. 3A-10B, device 10 has a flat peripheral surface 16. In other embodiments, the device may have curved surfaces. For example, FIGS. 11A-11C illustrate perspective top and side cross-sectional views, respectively, of a connector 400 the latter taken at line C-C illustrated in FIG. 11B. For purposes of illustration, the top housing surface is omitted from FIG. 11B. Connector 400 is formed in device housing 14′, which has a curved side surface 16′. Side surface 16′ has a window 132 at the end of channel 112. Connector 400 is otherwise identical to connector 200 described above, and like components are identified with like numerals. FIGS. 11A-11C illustrate connector 400 in a disengaged state, with magnets 102, 104A, and 104B withdrawn. In the engaged state of connector 400, magnets 102 and leads 116 protrude through window 132 and cooperate with peripheral surface 16′ to define a curved surface for interfacing with another connector 400. Once two connectors 400 are brought into abutment and engage one another, they may form a joint that can be pivoted around surface 16′. For example, FIG. 11D shows a side cross sectional view of two connectors 400 engaging one another and positioned at approximately a 90-degree angle to one another. Leads 116 are urged into contact with one another by magnets 102, forming an electrical connection for data or power transmission. FIG. 11E shows connectors 400 engaging one another at approximately a 180-degree angle. Since magnets 102 and leads 116 define a curved contact surface, connectors 400 may be pivoted between the positions of FIGS. 11D and 11E without breaking the electrical connection.

Connectors 100, 200, 300, and 400 have magnets 102, 104, 104A, and 104B mounted in channels to move generally in a single plane. Magnets 102, 104, 104A, and 104B move in a plane parallel to the front and rear surfaces of the respective device 10.

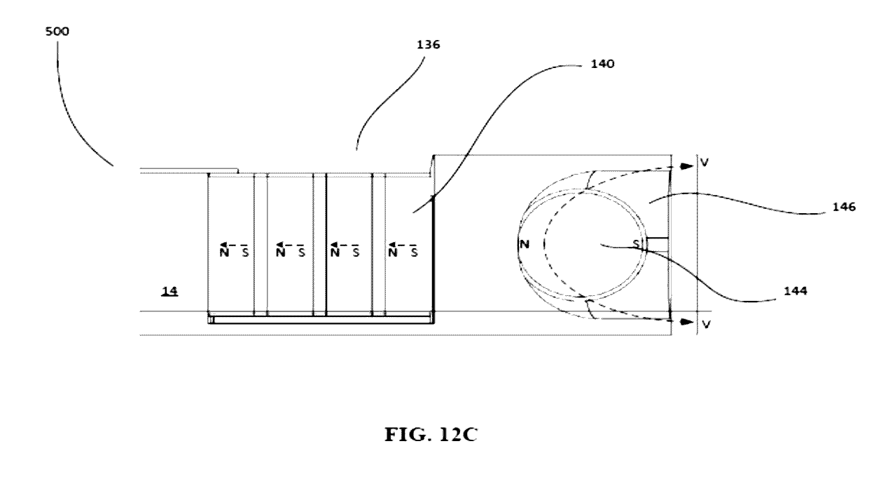

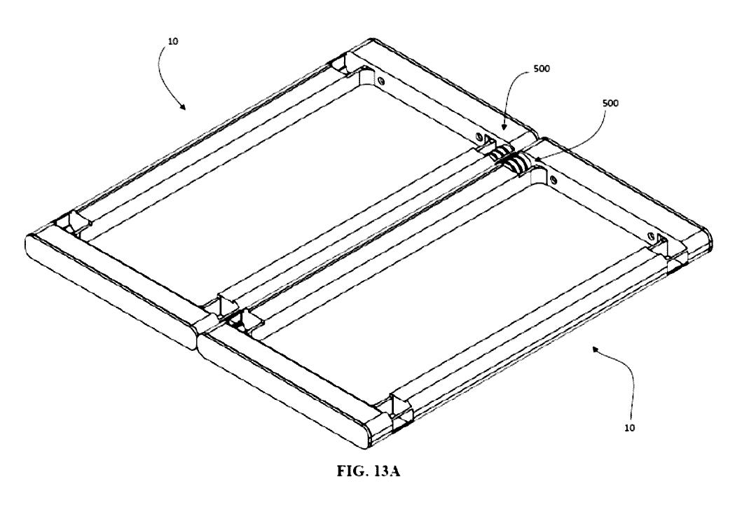

In some embodiments, magnets 102, 104, 104A, and 104B may be mounted such that they are movable in two different planes, which may be approximately orthogonal to one another. For example, FIG. 12A illustrates a perspective view of a device 10 with a connector 500 with magnets operable to slide laterally (toward a side of the device) and to slide forward and backward (toward the device's front or back surfaces).

Connector 500 includes a plurality of core magnets 140, like core magnets 102, mounted in a channel 142. Channel 142 leads to a first window 134 in a lateral surface of device 10 and a second window 140 in a front surface of device 10.

FIG. 12B illustrates an enlarged top cross-sectional view of connector 500 in its disengaged state. As noted, connector 500 includes a plurality of core magnets 140 slidably received in a channel 142. As illustrated, core magnets 140 are disk magnets. However, other suitable types of magnets may be used.

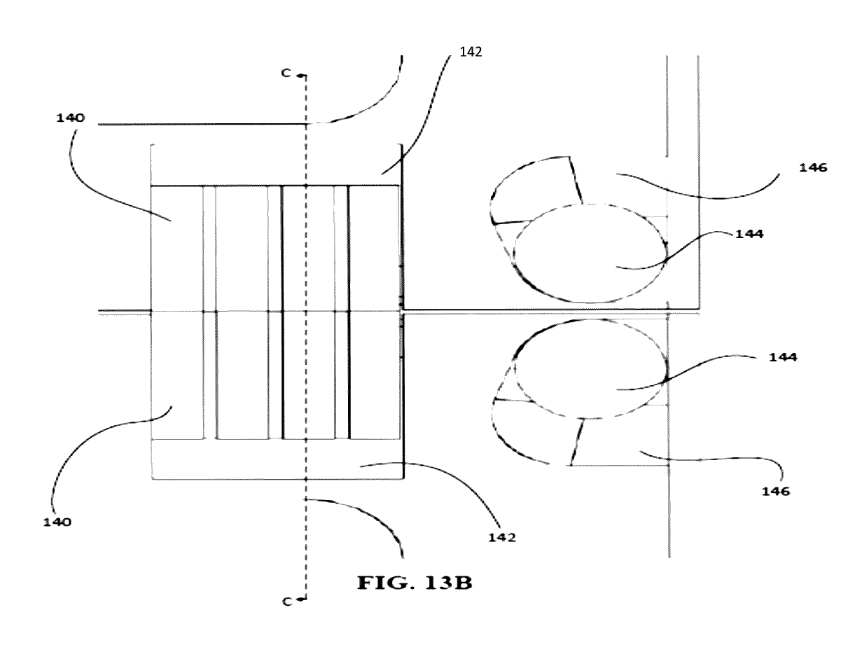

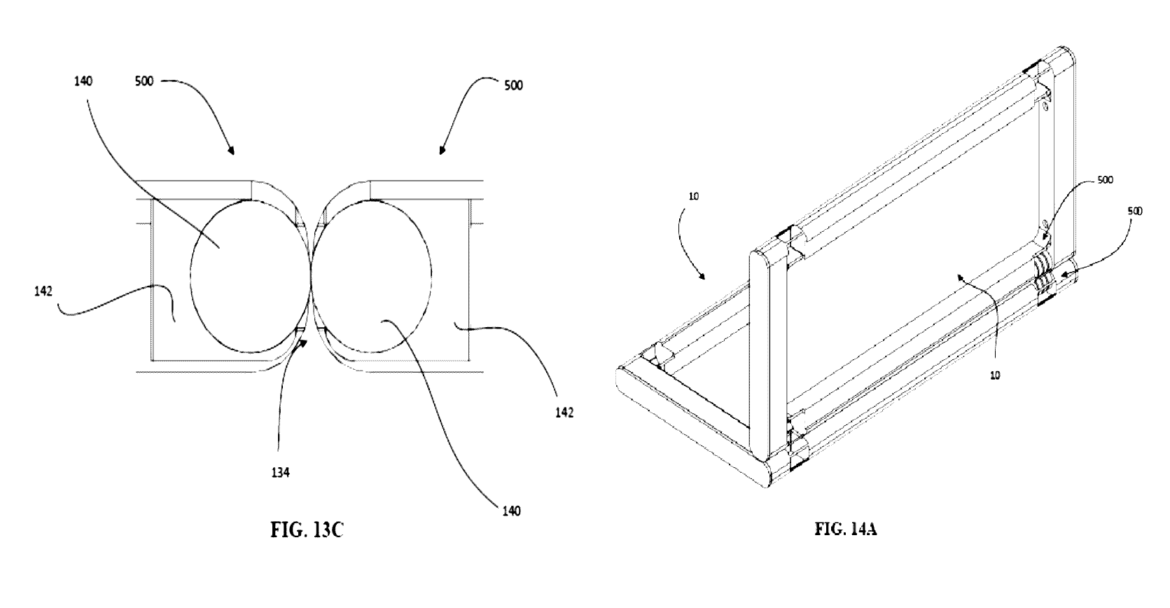

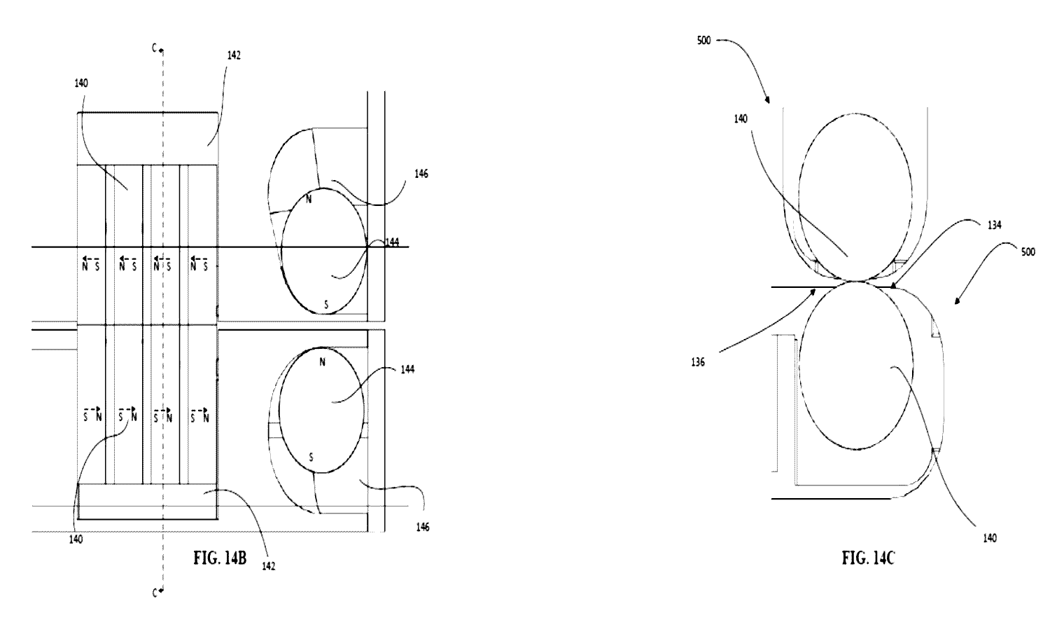

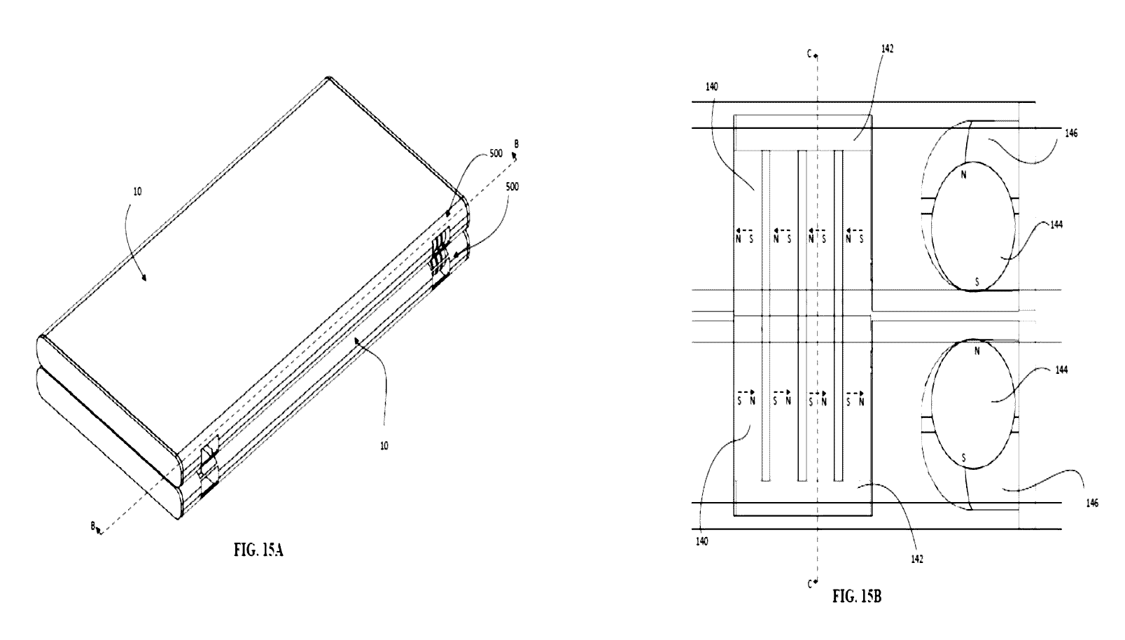

Connector 500 further includes a side magnet 144. Side magnet 144 is spherical. Side magnet 144 is slidably and rotatably received in a channel 146. Channel 146 extends from the interior of housing 14 toward side, top, front, and back edges of the housing to define a three-dimensional envelope within which magnet 144 is movable. Magnet 144 is movable between a first position, illustrated in FIG. 12B, in which magnet 144 is withdrawn relative to each of the side, top, front, and back surfaces of housing 14; a second position (as illustrated in FIG. 13B) in which magnet 144 is extended toward a lateral surface of housing 14 to switch connector 500 to an engaged state; and a third position (as illustrated in FIG. 14B) in which magnet 144 is extended toward a front or back surface of housing 14 to switch connector 500 to an engaged state. Channel 146 defines a first path between the first and second positions, identified by the arrows marked H-H in FIG. 12B, and a second path between the first and third positions, identified by the arrows marked V-V in FIG. 12C.

The first position of magnet 144, as illustrated in FIG. 12B, is the point in channel 146 closest to core magnets 140. Accordingly, in the absence of another connector, magnetic attraction between magnet 144 and magnets 140 biases magnet 144 to the first position. Magnetic attraction likewise biases magnets 140 to a withdrawn position within channel 142 substantially as described above regarding connectors 100, 200, 300, and 400. Magnetic attraction between magnet 144 and magnets 140 may also cause magnet 144 to rotate into alignment with magnets 140. As illustrated, the north-south alignment of magnets 140 is parallel to the lateral surface of housing 14. Accordingly, magnet 144 is rotated so that its north-south poles are parallel to the lateral surface of housing 14.

As illustrated in FIG. 13A, two devices 10 may be placed side-by-side so that connectors 500 abut one another on lateral sides of the devices 10. FIG. 13B shows a top sectional view of two connectors 500 in such a condition FIG. 13C shows a side cross-sectional view of the connectors 500 taken along line C-C in FIG. 13B.

In a manner similar to that described above with reference to connector 100, magnets 144 of adjacent connectors 500 magnetically attract one another sufficiently to overcome the bias between each magnet 144 and its respective core magnets 140. Magnets 144 are pulled toward one another and toward lateral surface 16 of housing 14. Because of such attraction, magnets 144 move along path H-H (FIG. 12B) to the second position, illustrated in FIG. 13B. Magnets 144 may also rotate to present opposite poles to one another. Meanwhile, continued attraction between magnets 140 and magnets 144 may hold magnets 144 in an orientation with north-south poles diagonal to lateral surface 16.

As described above regarding connector 100, as side magnet 144 is pulled toward lateral surface 16 and rotated, its biasing effect on magnets 140 is reduced. Accordingly, magnets 140 of the two connectors 500 attract one another and cause one another to move toward extended (engaged) positions. In the engaged position, magnets 102 may protrude through window 134 of housing 14.

As illustrated in FIG. 14A, two devices 10 may be placed in a T-configuration so that connectors 500 abut one another, with a top or bottom surface of one device abutting a lateral surface of another device. FIG. 14B shows a top sectional view of two connectors 500 in such a condition. FIG. 14C shows a side cross-sectional view of the connectors 500 taken along line C-C in FIG. 14B.

Magnets 144 of adjacent connectors 500 magnetically attract one another sufficiently to overcome the bias between each magnet 144 and its respective core magnets 140. Magnets 144 are pulled toward one another. One magnet 144 is pulled toward lateral surface 16 of its device housing 14 and moves along path H-H (as illustrated in FIG. 12B) to the second position. A magnet 144 of the other device is pulled toward a front or back surface of its device housing 14 and moves along path V-V (as illustrated in FIG. 12C). Magnets 144 may also rotate to present opposite poles to one another. During movement between the first and third positions, magnets 144 may rotate partly about each of a plurality of axes. Continued attraction between magnets 144 and magnets 140 may hold magnets 144 in an orientation with north-south poles diagonal to the front or back surface of the device housing 14.

As described above regarding connector 100, as side magnet 144 is pulled toward lateral surface 16 and rotated, its biasing effect on magnets 140 is reduced. Accordingly, magnets 140 of the two connectors 500 attract one another and cause one another to move toward extended (engaged) positions. In the engaged position, magnets 140 of one device may protrude through window 134 of that device's housing 14, while magnets 140 of the other device may protrude through window 136 of the other device's housing 14.

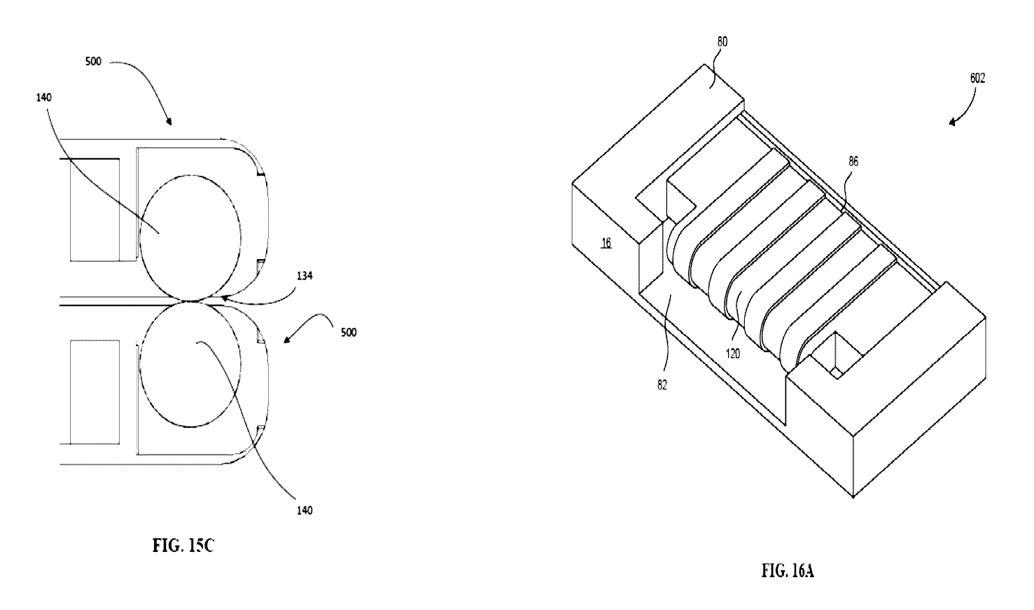

As illustrated in FIG. 15A, two devices 10 may be placed atop one another so that connectors 500 abut one another with a top or bottom surface of one device abutting a top or bottom surface of another device. FIG. 15B shows a side sectional view of two connectors 500 in such a condition taken along line B-B illustrated in FIG. 15A. FIG. 15C shows a side cross-sectional view of the connectors 500 taken along line C-C illustrated in FIG. 15B.

Magnets 144 of adjacent connectors 500 magnetically attract one another sufficiently to overcome the bias between each magnet 144 and its respective core magnets 140. Magnets 144 are pulled toward one another. Each magnet 144 is pulled toward a front or rear surface of its device housing 14 and moves along path V-V (as illustrated in FIG. 12B) to the third position. Magnets 144 may also rotate to present opposite poles to one another. During movement between the first and third positions, magnets 144 may rotate partly about each of a plurality of axes. Continued attraction between magnets 144 and magnets 140 may hold magnets 144 in an orientation with north-south poles diagonal to lateral the front or back surface of the device housing 14.

As described above regarding connector 100, as side magnet 144 is pulled toward lateral surface 16 and rotated, its biasing effect on magnets 140 is reduced. Accordingly, magnets 140 of the two connectors 500 attract one another and cause one another to move toward extended (engaged) positions. In the engaged position, magnets 140 of each device may protrude through window 136 of that device's housing 14.

In an example, channels 146 may be configured so that, in the first (disengaged) position, the minimum distance between magnets 144 and magnets 140 is approximately 2.9 mm; in the second position (as illustrated in FIG. 13B), the minimum distance between magnets 144 and the lateral surface of housing 14 is about 0.3 mm; and in the third position (as illustrated in FIG. 15B), the minimum distance between magnets 144 and the front or rear surface of housing 14 is about 0.7 mm.

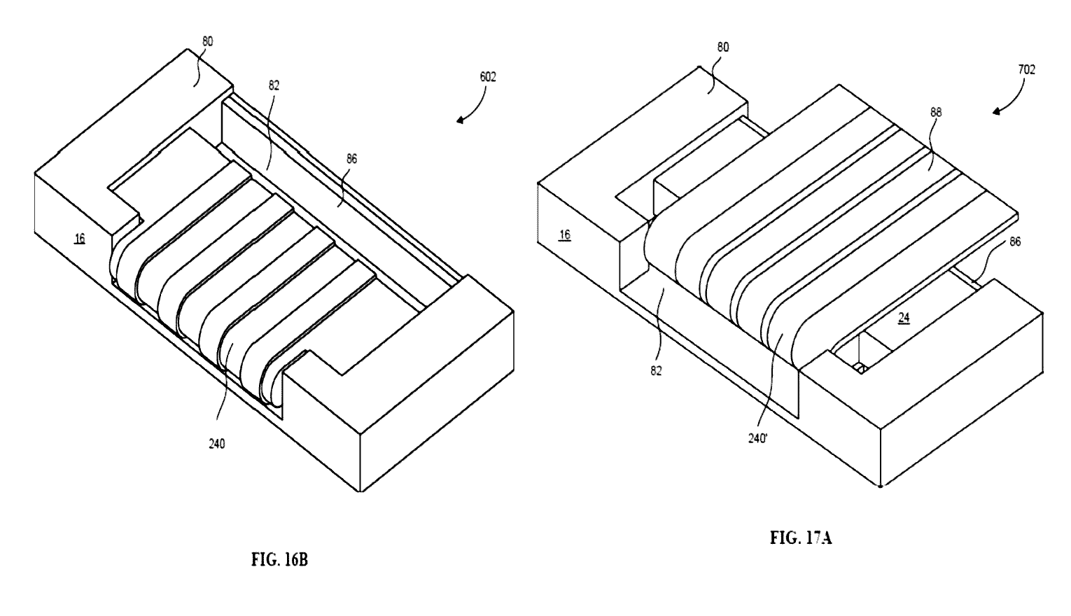

FIGS. 16A and 16B each is a perspective view of a connector 602 with top surfaces omitted for purposes of illustration. Connector 602 omits channels 110A or 110B and side magnets 104A or 104B of connector 300, and includes a ferrous stop 86 disposed along a rear wall of housing 80 in cavity 82. Connector 602 is otherwise substantially like connector 300. In FIGS. 16A and 16B, the top surface of housing 80 is not illustrated, for clarity of illustration.

Attraction between assembly 120 and ferrous block 86 biases assembly 120 to a retracted position within connector 602 (as illustrated in FIG. 16A). However, when connector 602 is brought into engagement with a corresponding connector 602, attraction between the two connectors 602 overcomes the biasing force provided by ferrous stop 86 and causes assembly 120 to move along the length of cavity 82 towards surface 16. Accordingly, assembly 120 moves to an extended position within connector 602 (as illustrated in FIG. 16B) such that connector 602 transitions to an engaged state, and forms magnetic and electrical connections with the corresponding connector. When the connectors 602 are disconnected, attraction between assembly 120 and ferrous block 86 moves assembly 120 back to its retracted position.

In an embodiment, ferrous block 86 may be formed from high-iron content carbon steel. However, ferrous block 86 may be formed from other magnetizable materials. In an embodiment, ferrous block 86 may be replaced with a biasing magnet disposed along the rear wall of housing 80 in cavity 82. This biasing magnet is selected to attract assembly 120 more weakly than a corresponding connector to which connector 602 may connect.

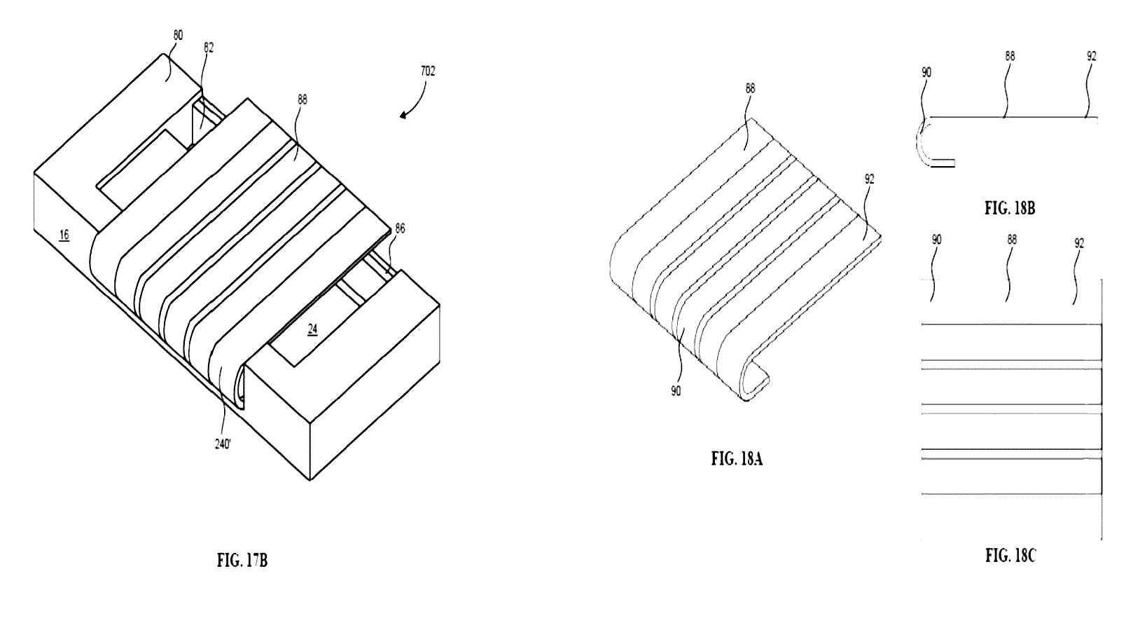

FIGS. 17A and 17B each is a perspective view of a connector 702. Connector 702 omits assembly 120, and includes an assembly 120′. Connector 702 is otherwise substantially like connector 602. In FIGS. 17A and 17B, the top surface of housing 80 is not illustrated, for clarity of illustration.

Assembly 120′ differs from assembly 120 in that electrical wires 130 are omitted. Instead, assembly 120′ includes a sleeve 88 that covers at least a part of magnet 122 including rounded end 128. Assembly 120′ is otherwise substantially like assembly 122.

As illustrated in FIGS. 18A, 18B, and 18C, sleeve 88 includes a first end 90 that wraps around rounded end 128 of magnet 122, and a second end 92 that extends towards the interior of housing 80.

The outer surface of sleeve 88 (at least at end 90) presents an array of contacts for forming electrical connections with another connector. In a specific example, each of these contacts may form a connection for a USB pin/wire, e.g., VCC, D−, D+, GND. Thus, a USB connection may be provided. In other embodiments, the sleeve may allow for a fewer or greater number of electrical connections. Connections other than USB (e.g., Firewire) may be provided. In embodiments in which sleeve 88 provides insulation between the contacts and magnet 122, further insulation is not required. For example, magnet 122 need not be coated with an insulating material.

In an embodiment, sleeve 88 may be a conventional FFC. Sleeve 88 is attached to magnet 122 (e.g., using adhesive) such that sleeve 88 and magnet 122 move together, e.g., when connector 702 transitions between an engaged state and a disengaged state. Like assembly 120, assembly 120′ is biased to a retracted position, and moves to an extended position when connector 702 is brought into engagement with a complementary connector. When connector 702 is in a disengaged state (as illustrated in FIG. 17A), sleeve 88 is pulled within housing 80. However, when connector 702 is in an engaged state (as illustrated in FIG. 17B), at least end 90 of sleeve 88 extends through an opening in the front wall of housing 80 (e.g., to connect with another connector, a metal surface, etc.).

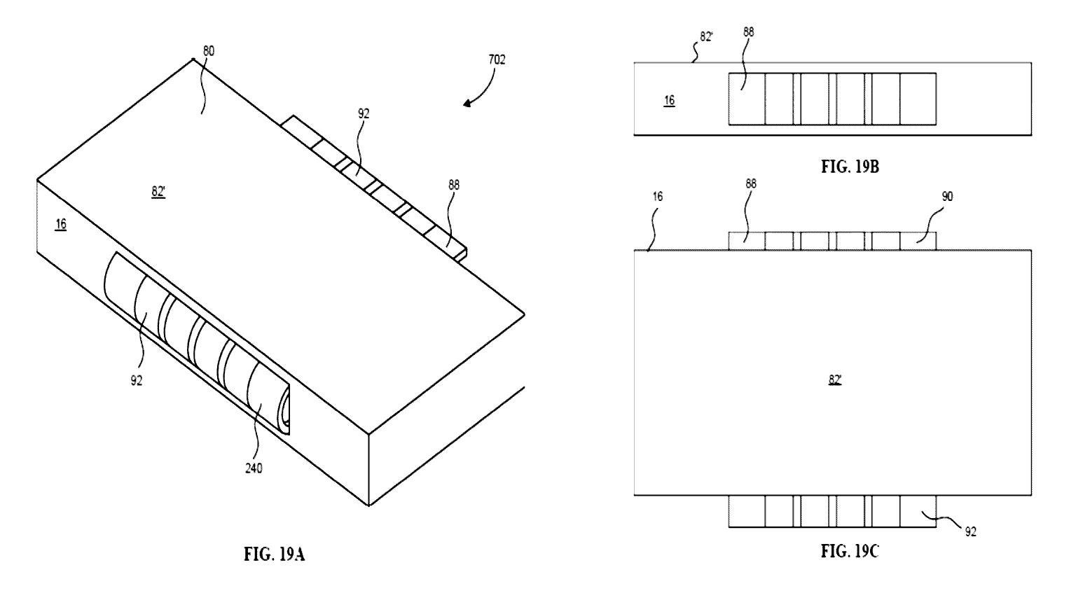

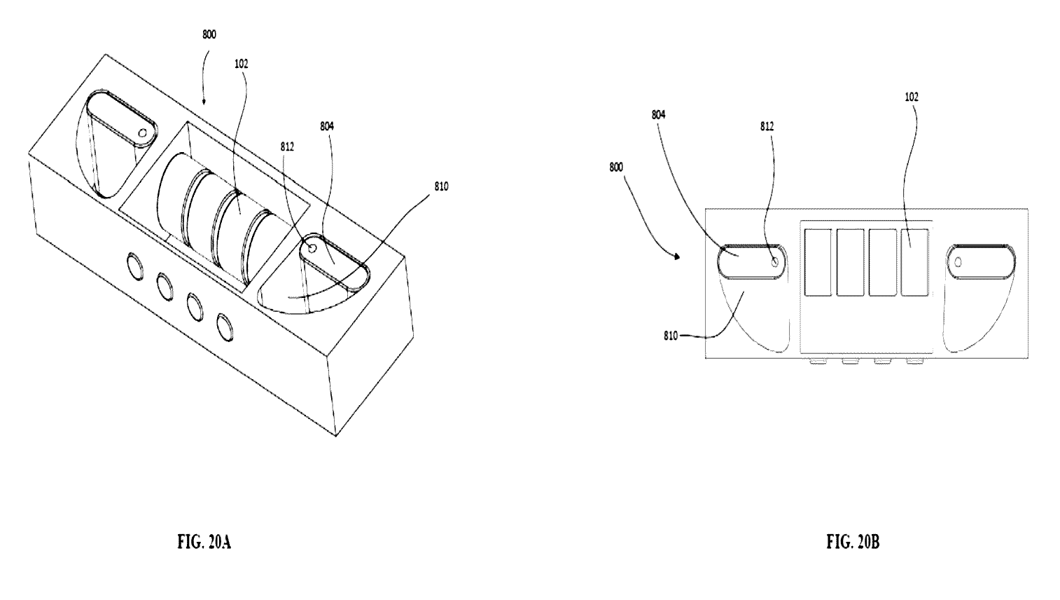

FIGS. 19A, 19B, and 19C are, respectively, a perspective view, a front view, and a top view of connector 702 with a top surface 82′ of housing 80 illustrated. In the illustrated embodiment, top surface 82′ does not include electrical contacts 84. Instead, internal circuitry of a device in which connector 702 is disposed may be connected directly to end 92 of sleeve 88.

In FIGS. 19A, 19B, and 19C, connector 702 is illustrated to be in its engaged state such that sleeve 88 of assembly 120 extends out of housing 80 (as illustrated in FIG. 19C). In another embodiment, connector 300 may be modified to include assembly 120′ instead of assembly 120.

As described above, side magnets 104, 104A, 104B are slidably and rotatably mounted in channels 110, 110A, 110B. In other embodiments, side magnets may be configured to rotate around a pivot.

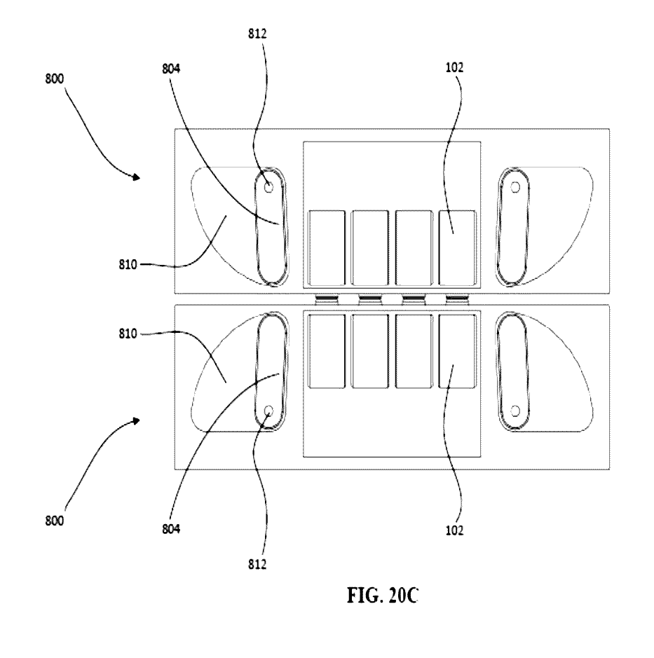

For example, FIGS. 20A and 20B illustrate perspective and top views, respectively, of a connector 800 with pivoting side magnets 804. Connector 800 is like connector 100 and have core magnets 102 mounted slidably in a channel 112, substantially identical to those of connector 100 described above. For the sake of illustration, top surfaces are omitted in FIG. 20B.

Magnets 804 are bar-shaped. Each magnet 804 is mounted proximate one of its ends to a pivot 812. Magnets 804 and pivots 812 are received in a channel 810. Magnet 804 is free to rotate about pivot 812. Pivots 812 and channels 810 cooperate to guide movement of magnets 804. The shape of channel 810 defines the range of rotation of magnet 804.

FIGS. 20A and 20B illustrate connector 800 in the disengaged state and FIG. 20C illustrates connectors 800 in the engaged state. Magnets 804 and 102 bias one another to the disengaged state. As illustrated, in the disengaged state, magnets 804 are rotated such that they are parallel to the edge of the connector. In this orientation, magnets 804 may be magnetically aligned with magnets 102 and magnetic attraction between magnets 804 and 102 may bias magnets 102 inwardly. When connector 800 is positioned adjacent another connector, attraction between side magnets 804 of the two connectors overcomes the bias between magnets 804 and 102 and causes the magnets 804 to rotate towards one another as illustrated in FIG. 20C. In the engaged position, the magnetic poles of magnets 804 may be oriented diagonally to the edge of connector 800. As described above, rotation of magnets 804 may reduce the inward biasing of magnets 102, which may in turn allow magnets 102 to draw one another into contact.

Other types of guides are possible. For example, magnets may be mounted to pins received in slots within the housing. Alternatively, the housing may define a single guide wall rather than a channel.

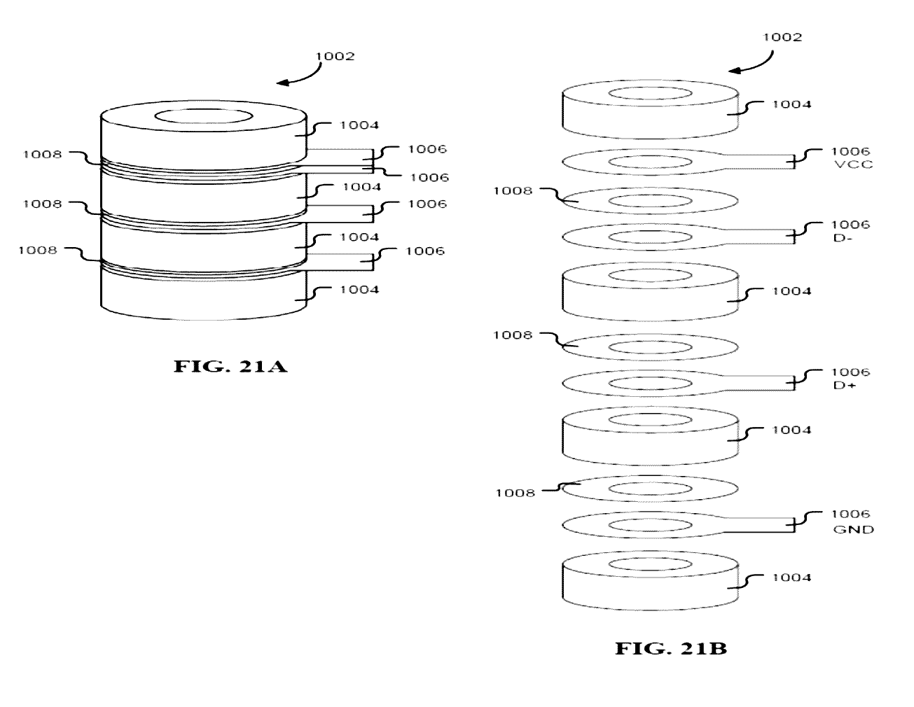

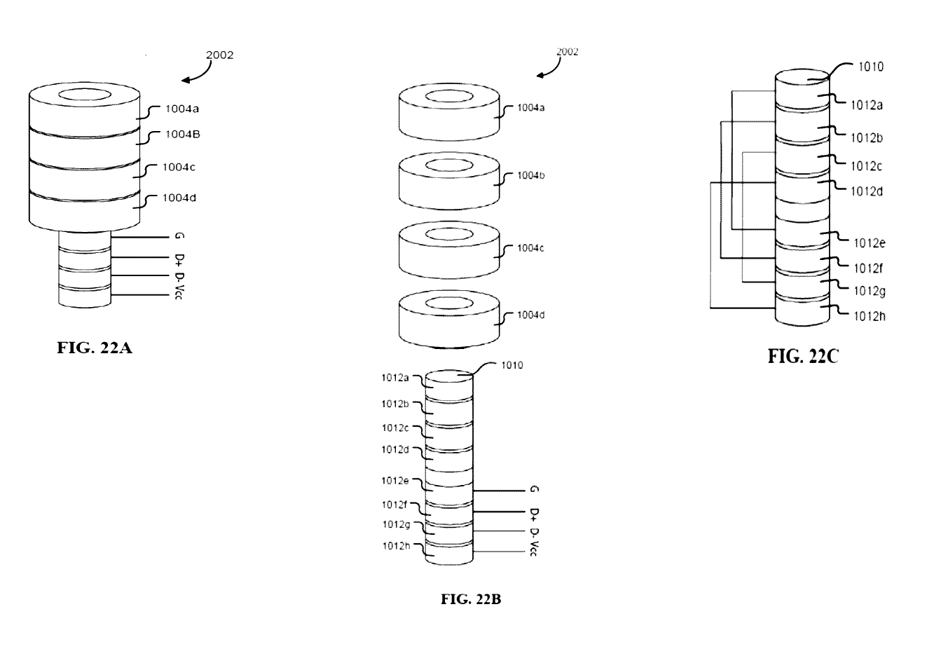

In some embodiments, core magnets 102 or 140 may be replaced with contact assemblies. FIG. 21A is a top perspective view of an example contact assembly 1002 and FIG. 21B is an exploded view of the same connector. As illustrated, contact assembly 1002 is formed from an interleaved stack of cylindrical magnets 1004, round conductive pads 1006, and round insulative pads 108. Contact assembly 1002 is cylindrical in shape.

Each magnet 1004 is substantially like a magnet 102 described above. Each magnet 1004 may attract and attach to a corresponding magnet (i.e., with an opposing polarity) on a connector of another device to establish electrical connections between the devices through the magnets.

Each conductive pad 1006 is formed from a thin layer of electrically conductive material, and is stacked in electrical communication with an associated magnet 1004. Each conductive pad 1006 includes a tab or pin that may be connected to a pin of an internal I/O interface of device 10 (as illustrated in FIG. 2B), to facilitate signal transmission between contact assembly 1002 and the internal I/O interface.

Each insulative pad 1008 is formed from a thin layer of electrically insulative material, and is stacked to provide electrical insulation between certain adjacent pairs of magnets 1004 and conductive pads 1006, as illustrated.

Collectively, the stack of magnets 1004, pads 1006, and pads 1008 allow a signal bus to be established through contact assembly 1002. This signal bus may conform to a conventional signaling standard such as the USB protocol. So, each conductive pad 1006 and associated magnet 1004 may carry a signal corresponding to a USB pin or wire, namely, VCC, D−, D+, GND. Thus, each contact assembly 1002 may carry signals in a manner like a conventional 4-pin USB connector. This allows device 10 to communicate through contact assembly 1002 using the USB protocol.

In other embodiments, contact assembly 1002 may be modified to include a stack having a greater or fewer number of magnets 1004, pads 1006, and pads 1008. For example, a greater number of magnets 1004, pads 1006, and pads 1008 may be included to increase bus width and thereby increase data throughput on the bus.

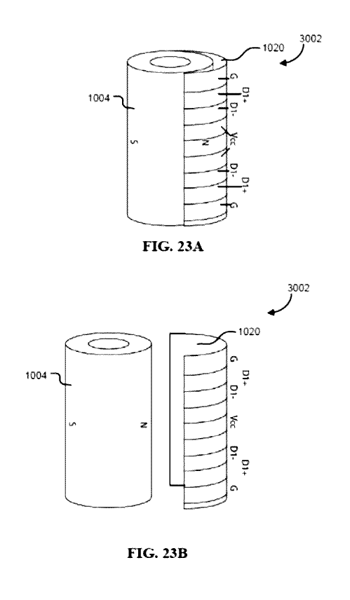

FIGS. 22A, 22B, and 22C show a contact assembly 2002, per another example embodiment, that may be used in place of contact assembly 1002. Each contact assembly 2002 is adapted to mate with another contact assembly 2002 on another device. When mated, connectors 2002 allow two devices to connect both mechanically and electrically. Contact assembly 2002 is cylindrical in shape.

FIG. 22A is a top perspective view of contact assembly 2002 including a stack of magnets 1004a, 1004b, 1004c, 1004d (collectively referred to as magnets 1004) and an elongate plug 1010 extending from a bottom end of the stack. Each magnet 1004 in the stack includes a hole extending therethrough such that a channel is formed through the stack for receiving plug 1010.

FIG. 22B is an exploded view of the contact assembly 2002 revealing the entire length of plug 1010 including its constituent segments 1012a through 1012h. FIG. 22C shows the interconnections between segments 1012a through 1012h of plug 1010.

In some embodiments, plug 1010 may be like a multi-connection phone plug (e.g., TRS plug) or bantam-type plug. As illustrated, plug 1010 includes a plurality of electrically isolated segments 1012a through 1012h, each presenting an outer contact surface formed from a conductive material. The segments 1012a through 1012h may each form a separate electrical connection.

As before, each magnet 1004 of contact assembly 2002 attracts and attach to a corresponding magnet on another contact assembly 1002 of another device to establish electrical connections between the devices through the magnets.

When a top end of plug 1010 (including segments 1012a through 1012d) is received within an interior channel defined by stacked magnets 1004; segment 1012a is in electrical communication with associated magnet 1004a; segment 1012b is in electrical communication with associated magnet 1004b; segment 1012c is in electrical communication with associated magnet 1004c; and segment 1012d is in electrical communication with associated magnet 1004d. Meanwhile, the bottom end of plug 1010 (including segments 1012e through 1012h) may extend into device 10 allowing segments 1012e through 1012h to interconnect with pins of an internal I/O interface of device 10.

At the same time, as illustrated in FIG. 22C, segment 1012a is electrically connected to segment 1012e; segment 1012b is electrically connected to segment 1012f; segment 1012c is electrically connected to segment 1012g; and segment 1012d is electrically connected to segment 1012h. In this way, each magnet 1004 may be connected to a pin of an internal I/O interface of device 10 through plug 1010.

Collectively, magnets 1004 and plug 1010 allow a signal bus to be established through contact assembly 2002. As before, this signal bus may conform to the USB protocol, and each magnet 1004 and interconnected segments of plug 1010 may carry a USB signal (VCC, D−, D+, GND), as illustrated in FIG. 22B.

FIGS. 23A and 23B show a contact assembly 3002, per another example embodiment, that may also be used in place of contact assembly 1002. Each contact assembly 3002 is adapted to mate with another contact assembly 3002 of another device. Contact assembly 3002 is cylindrical in shape.

As illustrated, contact assembly 3002 includes a sleeve 1020 that wraps at least partly around the vertical face of cylindrical magnet 1004. The outer surface of sleeve 1020 presents an array of contacts for carrying signals. When magnet 1004 of contact assembly 3002 attracts and attaches to corresponding magnet on a connector of another device, the contacts on sleeve 1020 form electrical connections with corresponding contacts on the connector of the other device.

Sleeve 1020 may be flexible. In an embodiment, sleeve 1020 may be a conventional flexible flat cable (“FFC”). Sleeve 1020 may include a coating formed from Teflon or similar material. Such a coating may protect sleeve 1020 from wear and tear during operation. Such a coating may also smoothen rotations of the devices relative to one another about a vertical axis of contact assembly 3002.

At least one end of sleeve 1020 is insertable into an interior of a device, such as device 10 (illustrated in FIGS. 1A-1C) for electrical connection with internal components of the device. In some embodiments, sleeve 1020 may wrap substantially or around the vertical face of cylindrical magnet 1004. When sleeve 1020 is wrapped substantially or wholly wrapped around the vertical face of magnet 1004, the free ends of sleeve 1020 may unite and press together to form a single flat cable that is insertable into a device such as device 10 (illustrated in FIGS. 1A-1C).

The length of sleeve 1020 may be adjusted, to wrap along a desired portion of the vertical face of magnet 1004, and to extend a desired distance into the interior of a device.

In some embodiments, contact assembly 3002 may include a thin shim interposed between sleeve 1020 and magnet 1004 when sleeve 1020 is wrapped around magnet 1004. The shim spans at least the portion of sleeve 1020 expected to contact another device (e.g., using a complementary connector on that device). In an embodiment, the shim may be a thin hollow cylinder that sheathes magnet 1004. The shim may be formed of brass. However, the shim could also be formed of another suitable material that is sufficiently malleable to be wrapped around portions of magnet 1004 and is sufficiently rigid to maintain its shape during operation. (e.g., as contact assembly 3002 meets other connectors). For example, the shim could also be formed of copper. In yet other embodiments, the shim could be formed of another metal, a carbon-based material, a plastic, or a composite material. In operation, the shim serves to spread out mechanical forces over the surface of magnet 1004, and minimizes point loads on magnet 1004. The shim also smoothens rotations of a device 10 (illustrated in FIG. 1A) relative to an interconnected device about a vertical axis of contact assembly 3002.

In some embodiments, the shim may be integral to sleeve 1020, and may, for example, be provided as a backing or substrate of sleeve 1020. In such embodiments, the shim may serve as a ground plane for sleeve 1020 (e.g., when the shim is formed of copper), and thereby facilitates signal transmission through sleeve 1020. The shim may also provide electromagnetic shielding. Collectively, the contacts on sleeve 1020 allow a signal bus to be established through contact assembly 3002. As before, this signal bus may conform to the USB protocol, and each may be assigned to carry a USB signal (VCC, D−, D+, GND, etc.), as illustrated in FIGS. 23A and 23B.

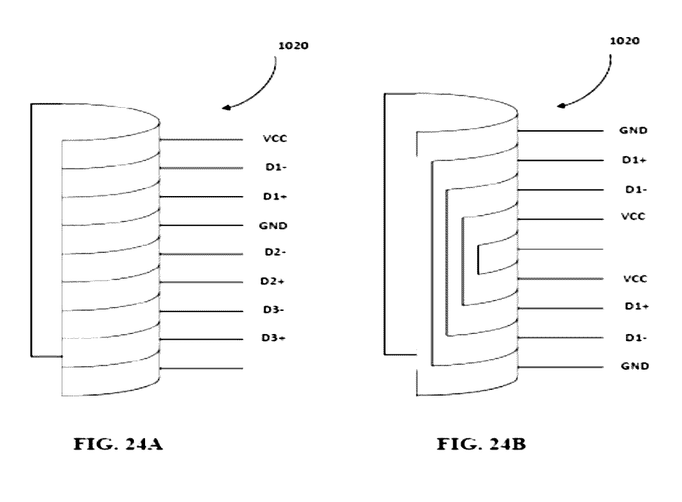

In one embodiment, each contact on sleeve 1020 may be used to carry a USB signal (VCC, D−, D+, GND, etc.), as illustrated in FIG. 24A. In this arrangement, three data channels may be provided, namely, D1, D2 and D3.

In another embodiment, the contacts on sleeve 1020 may be paired, and each pair of contacts may be electrically connected and used to carry a USB signal (i.e., one of VCC, D−, D+, GND, etc.), as illustrated in FIG. 24B. Further, the USB signals may be assigned to the contacts in a vertically symmetrical order. This redundancy of contacts and vertically symmetry allows contact assembly 3002 to be agnostic to its vertical orientation. In other words, contact assembly 3002 may be mated to another contact assembly 3002 to establish electrical and mechanical connections, regardless of their respective vertical orientations.

Of course, contact assemblies 1002 and 2002 may also be modified to have a similar redundancy and vertical symmetry of contacts (i.e., magnets 1004), to thereby provide connectors that are agnostic to their vertical orientation. The cylindrically shaped connectors described herein (e.g., contact assemblies 1002, 2002, and 3002) allow device 10 (illustrated in FIG. 1A) to be rotated about a vertical axis of the connector when connected to another device using that connector. This allows the orientation of device 10 (illustrated in FIG. 1A) to be adjusted relative to connected devices, without interrupting the mechanical or electrical connections therebetween. Embodiments of the cylindrically shaped connectors described herein (e.g., contact assemblies 1002, 2002, and 3002) may be genderless, and may mate with a like cylindrically shaped connectors.

In other embodiments, the cylindrically shaped connectors described herein may be modified to adhere to a protocol or connector pin-out format other than USB or to adhere to a custom protocol or connector pin-out format. In some embodiments, magnet 1004 (as illustrated in FIGS. 23A and 23B) of contact assembly 3002 may be replaced by a stack of cylindrical magnets 2004.

More than two devices may be interconnected. For example, the number of devices that be interconnected may be limited by total current draw of the devices, and the ability of protocols to uniquely identify interconnected devices. Various combinations of disparate devices may be interconnected. Moreover, in some embodiments, multiple connections could be formed between two devices. For example, in the case of devices with connectors at each corner, devices may be placed side-by-side, with two pairs of corners abutting one another. Connectors at each pair of corners may form connections. Multiple connections may be used for multiple data lanes, increasing data bandwidth between devices, or one connector could be used for data transmission and one for power transmission.

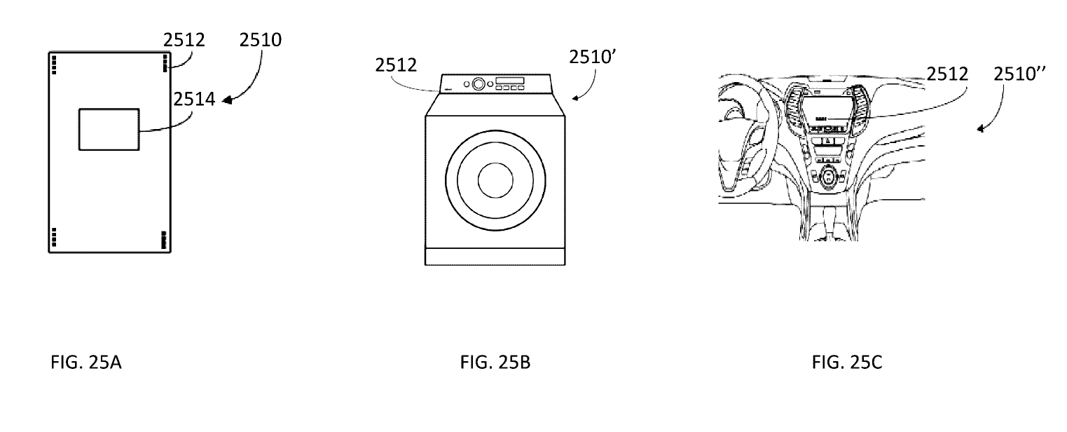

FIG. 25A illustrates a device 2510 including magnetic connectors 2512 at its corners. Device 2510 may be configured to function as a smartphone, and thus may include conventional smartphone components. For example, device 2510 may include electronics 2514 incorporating a suitable combination of processors, memory, I/O interfaces (e.g., wireless interfaces). Device 2510 may also have other components of a conventional smartphone such as a display, touchscreen sensors, etc., which are omitted for clarity of illustration. Device 2510 may have various other form factors (e.g., smart watch, tablet devices, etc.), and have fewer or more magnetic connectors, arranged at various locations on the device.

FIG. 25B illustrates a device 2510′ including magnetic connectors 2512. Device 2510′ may be configured to function as a washing machine. FIG. 25C illustrates magnetic connectors 2512 in vehicles and their accessories 2510″. For example, a car accessory may have multiple magnetic connectors 2512. Multiple car accessories 2510″ may be connected for mechanical stability and data transmission and data computing. Each accessory 2510″ may have one or more sensors for collecting data and have one or more actuators or output interfaces (e.g., speakers, indicators, motors, heaters, etc.). Sensors may be any type of conventional sensors, e.g., pressure, temperature, humidity, etc.

Such an accessory 2510″ can also operate as a key, enabling, or control device for a vehicle device, such as an automobile, or another land or water vehicle. For example, the accessory 2510″ can be a smart key that is recognized by the vehicle and interfaces to enable or optimize features of the vehicle. Other uses that can be linked to the accessory 2510″ using the magnetic connectors, such as heat or cooling feature of the vehicle, comfort aspect or seating setting, steering wheel position, security setting, etc. of the vehicle particular to and associated with, the user of the device. The accessory 2510″ can be targeted to parents who wish to share their car with adolescent or young adult drivers or rental companies who wish to prevent abuse to their fleet. Magnetic keys may be configured with a variety of settings. Magnetic features include speed control gives the owner the ability to limit the top speed using magnetic device. Volume control allows the owner to adjust the volume of the radio remotely using another magnetic device in communication (e.g. wirelessly or cellular) with magnetic accessory 2510″. The magnetic accessory 2510″ can remind the driver to buckle their seat belt by muting the vehicle's radio and chiming for six seconds every minute for five minutes. The magnetic accessory 2510″ can include a custom fuel reminder and a speed reminder chime increments of speed. The magnetic accessory 2510″ can disable texting when connected to the vehicle. The magnetic accessory 2510″ can be used for remote monitoring via the magnetic accessory 2510″ of all aspects of operation of the vehicle. The magnetic accessory 2510″ can be used to remotely view the operation of the vehicle by an operator using a camera and/or microphone of the magnetic accessory 2510″. The magnetic accessory 2510″ can be used to monitor distractions in the vehicle remotely and/or record activity therein. The magnetic accessory 2510″ may be used to alert a parent, repair company, insurance company, etc.

Due to the magnetic connector 2512 of the accessory in relation to the vehicle connection, positioning of the device in the vehicle is known. And, a position of the driver relative thereto is also known. For example, in the United States, the driver would be to the left of the accessory and the passenger would be to the right of the accessory within the vehicle (the opposite would be true in the UK, for example). Based on this recognized positions of the driver and passenger(s), which may be sensed by an airbag sensor of the vehicle, settings of the car can be made and can be customized using the magnetic accessory 2510″.

Similarly, a weight of the passenger can be known and input to the accessory or sensed by the vehicle and based on this weight sensed by the vehicle the passenger may also be recognized or sensed correctly. For example, in a common family where the accessory 2510″ is associated with the driver, the passenger may be assumed to be a spouse when a certain weight is sensed in the passenger seat. Based on this, the passengers in the rear may be considered to be children. When the weight of the passenger in the passenger seat is less than a recognized weight of the spouse, the settings for the passenger may be associated with a child of the driver, and so forth. Thus, based on the driver being associated with the accessory 2510″ connected to the vehicle, attributes of the front passenger may also be set or assumed based on a sensor, e.g. weight sensor, attribute of the vehicle.

When not in the vehicle, the key-related magnetic accessory 2510″ can be associated with an accessory charging station (e.g. a docking station or bay) similar to a traditional key device. This charging station can be located by the door or on a dresser, except that the charging station can include a charging bay that includes a magnetic connection charging station.

Removal of the accessory 2510″ from the magnetic connector 2512 of the vehicle or other device can also initiate protocol or operation of the accessory based on the lack of connection, and this lack of magnetic connection can be used as an initialization signal. For example, a door of the vehicle may lock, the vehicle may turn off, or security measures may be associated with a lack of magnetic connection between the accessories. And, this magnetic connection aspect can be referred to as a magnetic signal. These magnetic signals can be stored, accessed and/or associated with a time, signal, and data.

Moreover, the accessory 2510″ can be used to unlock a mechanical lock also similar to a key or a smart card or smart access point. This mechanical lock can be battery operated and include an internal power source or use a power source of the device accessory to enable mechanical unlocking of the locking device. This locking device may be part of the vehicle or may be a separate product used to secure the vehicle using a magnetic connection for authentication, for example.

Authentication of the device can be made in coordination with the vehicle or other electronic device. For example, the electronic device can include an electronic key or magnetically stored key as part of the magnetic connector. This authentication key can be used to “unlock” or otherwise make the vehicle or other device available or operational for the user.

The accessory 2510″ can further include a scanning device to authenticate the user of the accessory when authenticating with the connected device. The magnetic connectable accessory 2510″ may also authenticate the user by facial recognition or biometric aspects such as by a finger print or a facial recognition.

Another example of a land vehicle that can use a magnetic device in combination therewith is the Segway. Computers, sensors, and electric motors in the base of the Segway keep the device upright when powered on with balancing enabled. As explained above, magnetic devices can be used to sync the user preferences with the computers, sensors, and electric motors to achieve the desired result.

A magnetic connectable device can also be used in connection with a drone electronic device. For example, a camera of a magnetic device can be used by the drone electronic device to take pictures. Pictures taken from the magnetic drone device can be streamed to the controller/user via wireless connectivity of the magnetic device. As explained above, magnetic devices can be used to sync the user preferences with the computers, sensors, and electric motors in the drone to achieve the desired result.

An electronic magnetic device can also be used with a self-driving car device that can be used in an autonomous vehicle. Autonomous vehicles sense their surroundings with such techniques as radar, lidar, GPS, Odometry, and computer vision, which data can be communicated to the magnetic device.

As discussed in further detail hereinafter, magnetic connectors may also be included in a variety of other devices, such as household appliances such as washing machines 2510′ (as illustrated in FIG. 25B) vehicles, consumer electronic devices, industrial machinery, furniture, wearable articles, clothing, and wearable electronics, etc. Such devices may be configured with suitable electronics and logic for establishing a data link with a device, e.g., through a magnetic connector or through a wireless connection (e.g., WiFi, Bluetooth, or the like).

Other accessories that include one or more magnetic connectors for connecting to electronic magnetic devices are further included within this disclosure. For example, ports, docking stations, cables, electronic peripherals, speakers, microphones, sensors, cameras, toys, displays, printers, and any other electronic device (whether it includes a processor, memory, active or passive electronics) is included within and in combination with the more specific embodiments of the electronic magnetic devices mentioned herein. Such accessories are encompassed whether separate from, or in combination, with the magnetic devices.

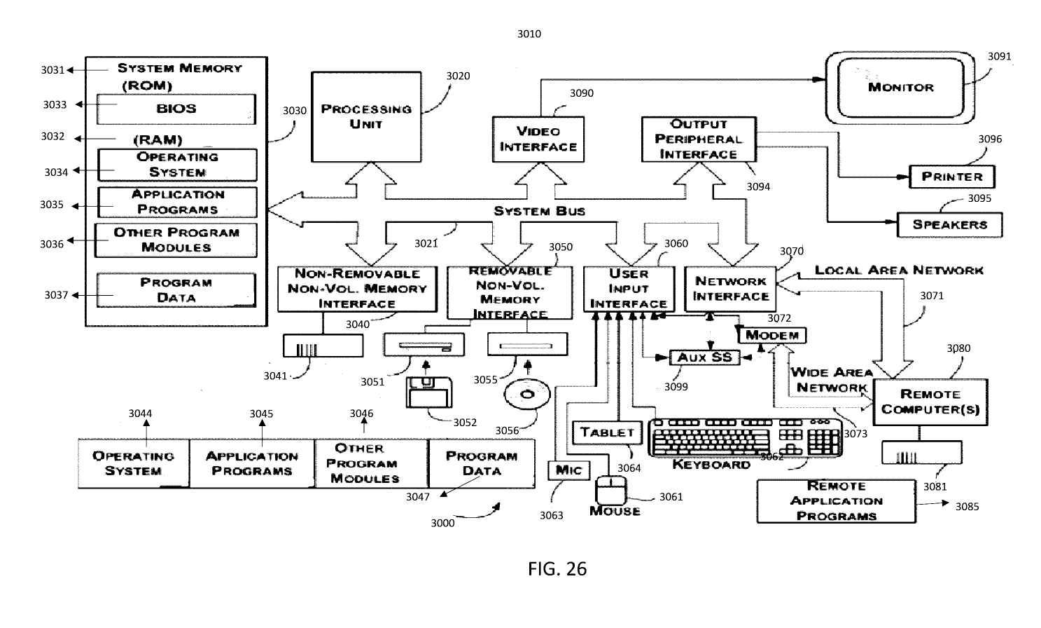

FIG. 26 illustrates a computing system 3010 that includes various examples of devices with magnetic connectors. The individual devices of the computing system 3010 can include magnetic connectors. The computing system 3010 itself can include one or more magnetic connectors for external connection to peripheral devices via magnetic connectors as illustrated therein or in any combination or derivation thereof. This computing system 3010 can be a computer. With only some or various components this computing system 3010 can represent components of a smart phone, tablet computing device, laptop, etc. Thus, any device illustrated therein can individually include a magnetic connector as a magnetic device or any device illustrated therein in combination with any other individual device in combination may also be referred to as a magnetic device. Moreover, an internal device or element illustrated may be considered in combination with any external device illustrated as a magnetic device including one or more magnetic connector(s). A magnetic device can also include connections of such devices in series, parallel, multiplicities, and in various permutations.

Components of the magnetic device 3010 may include, but are not limited to, a processing unit 3020, a system memory 3030, and a system bus 3021 that couples various system components including the system memory to the processing unit 3020, each of which may be considered a magnetic device individually or in various combinations. The system bus 3021 may be any of several types of bus structures including a memory bus or memory controller, a peripheral bus, and a local bus using any of a variety of bus architectures. Such architectures include but are not limited to Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer magnetic device 3010 can include a variety of computer-readable media, which can be connected using a magnetic connector. Computer-readable media can also be considered a magnetic device including a magnetic connector and can be any available media that can be accessed by the computer magnetic device 3010 and includes both volatile and nonvolatile media, and removable and non-removable media. Computer-readable media may comprise computer storage media and communication media, as discussed above.

The system memory 3030 includes computer storage media in the form of volatile and/or nonvolatile memory such as read only memory (ROM) 3031 and random access memory (RAM) 3032, which can also be configured for communication over a magnetic connector. A basic input/output system 3033 (BIOS) containing the basic routines that help to transfer information between elements within computer 3010, such as during start-up, is typically stored in ROM 3031. RAM 3032 typically contains data and/or program modules that are immediately accessible to and/or presently being operated on by processing unit 3020. FIG. 26 illustrates operating system 3034, application programs 3035, other program modules 3036 and program data 3037.

Certain programs and applications may also be configured for communication over a magnetic connector. For example, to the extent that an algorithm or software performs steps and/or acts particular to a magnetic connector, such algorithms and software can be termed magnetic protocol or magnetic processes. As such, to the extent that the form or processing of data is due to communication over a magnetic connector, such software and processes are further considered under the disclosure herein.

In the instance that certain functional data structures or data structures are achieved and/or obtained per such magnetic processes, connections, and/or protocols such data structures are further included herein. And, to the extent that the magnetic connector is used in connection with such software and structure design, such magnetic processes, connections, and/or protocols are further disclosed herein.

The computer 3010 may also include other removable/non-removable, volatile/nonvolatile computer storage media. FIG. 26 further illustrates a hard disk drive 3041 that reads from or writes to non-removable, nonvolatile magnetic media, a magnetic disk drive 3051 that reads from or writes to a removable, nonvolatile magnetic disk 3052, and an optical disk drive 3055 that reads from or writes to a removable, nonvolatile optical disk 3056 such as a CD ROM or other optical media. Such examples of magnetic devices can include or be coupled with a magnetic connector within or external to the computer magnetic device 3010.

The hard disk drive 3041 is typically connected to the system bus 3021 through a non-removable memory interface such as interface 3040, and magnetic disk drive 3051 and optical disk drive 3055 are typically connected to the system bus 3021 by a removable memory interface, such as interface 3050, which are all examples of devices that can be directed or indirectly coupled to one or more magnetic connectors and may be described as a magnetic device, as in such examples.

The drives and their associated computer storage media, described above and illustrated in FIG. 26 above (among other figures and in other combinations and rearrangements), provide storage of computer-readable instructions, data structures, program modules and other data for the computer 3010. In FIG. 26 for example, hard disk drive 3041 is illustrated as storing operating system 3044, application programs 3045, other program modules 3046 and program data 3047. Note that these components can either be the same as or different from operating system 3034, application programs 3035, other program modules 3036, and program data 3037.

Operating system 3044, application programs 3045, other program modules 3046, and program data 3047 are given different numbers herein to illustrate that, at a minimum, they are different copies. A user may enter commands and information into the computer 3010 through input devices such as a tablet, or electronic digitizer, 3064, a microphone 3063, a keyboard 3062 and pointing device 3061, commonly referred to as mouse, trackball or touch pad. Other input devices not illustrated in FIG. 26 may include a joystick, game pad, satellite dish, scanner, or the like which can be coupled to the computer and/or various devices illustrated via one or more magnetic connectors. These and other input devices are often connected to the processing unit 3020 through a user input interface 3060 that is coupled to the system bus 3021 (e.g. via magnetic connection(s)), but may be connected by other interface and bus structures, such as a parallel port, game port or a universal serial bus (USB) via a magnetic connection(s). A monitor 3091 or other type of display device is also connected to the system bus 3021 via an interface, such as a video interface 3090 via a magnetic connector. The monitor 3091 may also be integrated with a touch-screen panel or the like via a magnetic connector. Note that the monitor and/or touch screen panel can be physically coupled to a housing via a magnetic connector in which the computing device 3010 is incorporated, such as in a tablet-type personal computer (i.e. another example of the many magnetic devices disclosed herein). In addition, computers such as the computing device 3010 may also include other peripheral output magnetic devices such as speakers 3095 and printer 3096, which may be connected through an output peripheral magnetic interface 3094 or the like.

The magnetic device can include a transferable computer-readable media with a magnetic connection conforming to a connection standard, such as USB or hard drive interface. Hard disk drives are accessed over one of several bus types, including as of 2011 parallel ATA (PATA, also called IDE or EIDE; described before the introduction of SATA as ATA), Serial ATA (SATA), SCSI, Serial Attached SCSI (SAS), and Fibre Channel. Bridge circuitry is sometimes used to connect hard disk drives to buses with which they cannot communicate natively, such as IEEE 1394, USB, SCSI and Thunderbolt. Any pin set or configuration and combination can be provided using the magnetic connectors.

The computer 3010 may operate in a networked environment using logical connections to one or more remote magnetic computers, such as a remote computer 3080. The remote computer 3080 may be a magnetic personal computer, a magnetic server, a magnetic router, a magnetic network PC, a magnetic peer device or other magnetic network node, and includes many or all the elements described above relative to the computer 3010 via direct or indirection use of a magnetic connector, although only a memory storage device 3081 has been illustrated in FIG. 26. The logical connections illustrated in FIG. 26 include one or more local area networks (LAN) 3071 and one or more wide area networks (WAN) 3073, but may also include other networks. Such networking environments are commonplace in offices, enterprise-wide computer networks, intranets and the Internet.

When used in a magnetic LAN networking environment, the computer 3010 is connected to the LAN 3071 through a magnetic network interface or adapter 3070. When used in a WAN networking environment, the computer 3010 typically includes a modem 3072 or other means for establishing communications over the WAN 3073, such as the Internet. The modem 3072, which may be internal or external, may be connected to the system bus 3021 via the user input interface 3060 or other appropriate mechanism. A wireless networking component 3074 such as comprising an interface and antenna may be coupled through a suitable device such as an access point or peer computer to a WAN or LAN. In a networked environment, program modules illustrated relative to the computer 3010, or portions thereof, may be stored in the remote memory storage device. FIG. 26 illustrates an exemplary embedment of a remote application magnetic programs 3085 as residing on memory device 3081. The illustrated embodiments are exemplary and other means of establishing a communications link between the computers may be used.

An auxiliary magnetic subsystem 3099 (e.g., for auxiliary display of content) may be connected via the user interface 3060 to allow data such as program content, system status and event notifications to be provided to the user, even if the main portions of the computer system are in a low power state. The auxiliary subsystem 3099 may be connected to the modem 3072 and/or network interface 3070 to allow communication between these systems while the main processing unit 3020 is in a low power state.

The communication via a magnetic connector can be in addition to other wireless communication. Wireless communication can be used to perform handshaking to authorize a data connection through a magnetic connector. In some embodiments, wireless communication may be used to provide a data channel that supplements any data channel established through magnetic connectors. In some embodiments, the magnetic connectors provides only a mechanical connection function, and communication is performed wirelessly for a wireless communication system such as Near Field Communication, (“NFC”), WiFi, and/or Bluetooth.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. Communication media includes wired media such as a wired network or direct-wired connection, and wireless media such as acoustic, RF, infrared and other wireless media. Combinations of the any of the above may also be included within the scope of computer-readable media. Thus, both Bluetooth and NFC communication can exist on a magnetic connected or enabled device.

Other embodiments of magnetic devices also include magnetic devices used in combination with another display device. Such magnetic devices can include magnetic media streaming devices and one or more magnetic display (or one or more magnetic television). Such magnetic media devices can include various combinations of the magnetic components disclosed herein.

Examples of pins of a magnetic connector can include pins defined by the HDMI, USB, and other digital standards as magnetic connectors. magnetic devices include digital consumer electronics, such as digital video displays, digital video disk (DVD) readers, flat screen computer monitors, high definition television (HDTV), digital plasma screens, digital audio readers, digital audio encoders, digital audio amplifiers, and digital audio processing devices including or coupled to one or more magnetic connectors. Some may be referred to as a magnetic data source device to another (or multiple) magnetic sink devices.

The HDMI interface is provided for transmitting digital television audiovisual signals from DVD players, set-top boxes and other audiovisual source devices to HDMI sink devices, such as television sets, projectors and other audiovisual devices, and can include magnetic HDMI connectors. Magnetic HDMI can carry multi-channel audio data and can carry standard and high definition consumer electronics video formats. Content protection technology is also available. HDMI can also carry control and status information in both directions.

To transmit audio and auxiliary data across the TMDS channels of a magnetic HDMI connector, HDMI uses a packet structure. To attain higher reliability of audio and control data, these data are protected with an error correction code and are encoded using a special error reduction coding to produce the 10-bit word that is transmitted. Optionally, HDMI can carry a single such stream at sample rates up to 192 kHz or two to four such streams (3 to 8 audio channels) at sample rates up to 96 kHz. HDMI can also carry compressed (e.g., surround-sound) streams. The DDC channel is used by the HDMI source device to read the HDMI sink device's Enhanced Extended Display Identification Data (E-EDID) to discover the sink device's configuration and/or capabilities. The HDMI source device reads the sink device's E-EDID and delivers only the audio and video formats that are supported by the sink device. In addition, the HDMI sink device can detect InfoFrames and process the received audio and video data appropriately. Such cables and connectors defined by the HDMI, USB, and other protocols over a magnetic connector or magnetic interface or cable is deemed a magnetic protocol as it is effected by the magnetic connector.

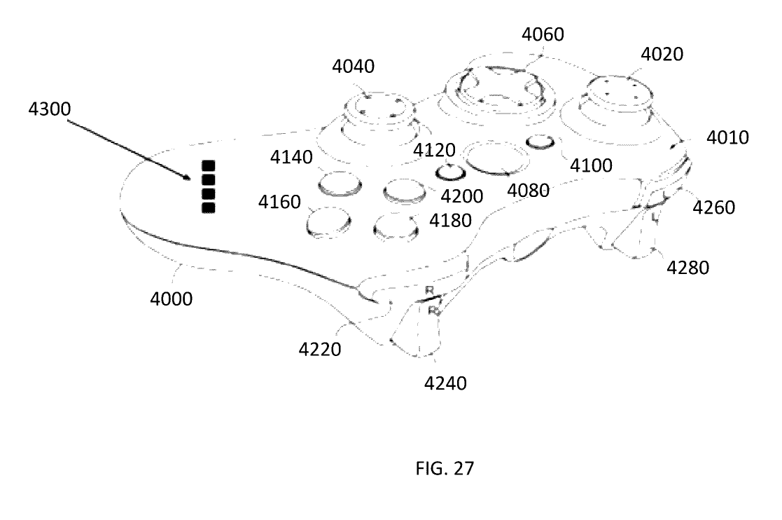

The magnetic device can also be a controller with mechanical, physical, and/or virtual controls that can be coupled to a magnetic control computing device. An example of a magnetic game controller 4000 is illustrated in FIG. 27 with a magnetic connector 4300 used with a magnetic hub such as a magnetic gaming unit including a magnetic connector to connecting to a controller, display, or being the display itself. The video game machine can be a console, such as a PlayStation, XBOX, or Nintendo for example, can be a computer, handheld, cell phone, Game boy, PSP, etc. or a functional combination of the components thereof also with a magnetic connector 4300.

A magnetic gamepad 4000 is illustrated in FIG. 27. The gamepad 4000 comprises several controls that are examples, including a left stick 4020 and a right stick 4040. Gamepad controls on the top side 4010 of gamepad 4000 includes a direction pad 4060, a guide button 4080, a back button 4100, a start button 4120, and face buttons 4140, 4160, 4180, and 4200. Other gamepad controls on the gamepad 4000 are a right bumper 4220 and a right trigger 4240. The gamepad 4000 also includes a left bumper 4260 and a left trigger 4280.

The left hand may control the left stick 4020 along with the left bumper 4260 and the left trigger 4280. A user may prefer to control the left stick 4020 with his left thumb, the left bumper 4260 with his left index finger, and the left trigger 4280 with his left middle finger. The right hand may control the right stick 4040 along with the right bumper 4220 and the right trigger 4240. A user may prefer to control the right stick 4040 with his right thumb, the right bumper 4220 with his right index, and the right trigger 4240 with his right middle finger. The face buttons 4140, 4160, 4180, and 4200 may also be controlled by the user's right hand.

The game console (e.g. a game media server) can also display the sports video game on only a portion(s) of a screen such that the player(s) can view the real-life games on another portion of the screen. In multi-player fantasy video game play the screen can be divided into multiple portions, one for each player of the multi-player game.

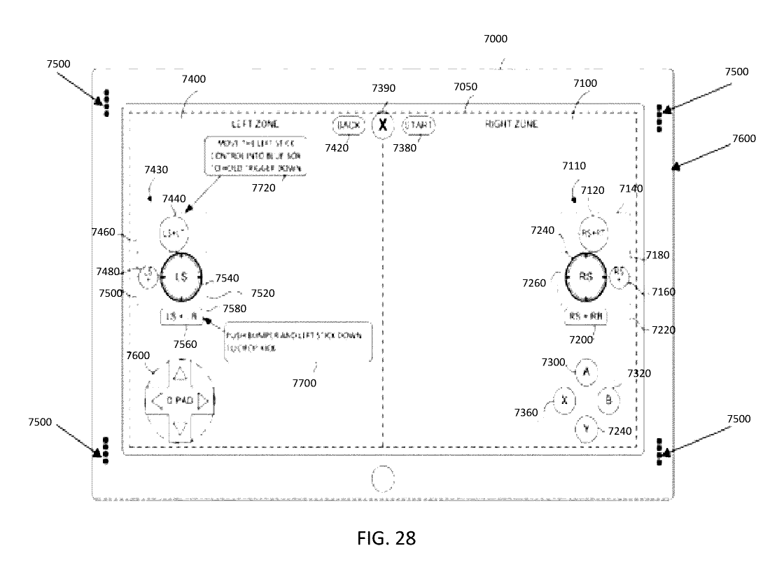

The magnetic controller can also have such buttons and tabs virtually represented on a touch screen input device as illustrated in FIG. 28. The magnetic device 7600 including the magnetic connectors 7500 and a virtual control interface 7050 includes many of the controls found on gamepad 4000 described previously. Similar virtual illustrations can be used regarding television and cable controls, for example. In this example, the virtual control interface 7050 is divided into a right zone 7100 and a left zone 7400. Controls within the right zone 7100 are optimized for interaction with the user's right hand. The controls within the left zone 7400 are optimized for interaction with the user's left hand. The user's hands are not illustrated, but the user could be holding the device or the device could be resting on a surface. The start button 7380, the guide button 7390, and the back button 7420 are located at the top of the virtual control interface 7050.

The right zone 7100 includes the right stick group 7110 and face buttons 7300, 7320, 7340, and 7360. In one aspect, the face buttons are in a static. In other words, the face buttons can hold a location in the lower right corner of the virtual control interface 7050 even as other controls may have a variable location. In one aspect, the arrangement of the face buttons is inverted compared to the arrangement found on the gamepad. The face buttons are round, each the same size, and arranged in a diamond pattern. The face buttons may be displayed in a color found on an associated gamepad. The color of buttons on different game pads may vary. The virtual controller interface can match the color of a gamepad selected by the user.

The right stick group 7110 can start in a location where the user initially interacts with the touch screen. For example, when the user places an implement, such as his thumb, middle, or index finger on the touch screen at the right stick box 7260. The virtual right stick control 7240 is then displayed within the right stick box 7260. The virtual right stick control 7240 may be manipulated by moving a finger in different directions. Other functions within the right stick group 7110 are arranged around the right stick box 7260 and may be activated in a variety of ways.

The user may tap the virtual right trigger control 7120 with an index finger while manipulating the virtual right stick control 7240 with his thumb. Alternatively, the user may hold his finger, or other implement, on the virtual right trigger control 7120 to generate a rapid fire command that is the equivalent to pulling the trigger repeatedly in rapid succession. Alternatively, the user may control the virtual right stick control 7240 and “pull” the virtual right trigger control 7120 located within right trigger box 7140 by dragging the virtual right stick control 7240 into the right trigger box 7140. This allows the user to control the virtual right stick control 7240 and the virtual right trigger control 7120 with a single finger. While in the right trigger box 714 the user may move her finger in a circular direction to manipulate the virtual right stick control 7240.

The user may tap the virtual right bumper control 7200 located within right bumper box 7220. Holding a finger on the virtual right bumper control 7200 can produce a rapid push command that is the equivalent to pushing the bumper repeatedly in rapid succession. Alternatively, the user may control the virtual right stick control 7240 and push the virtual right bumper control 7200 by dragging the virtual right stick control 7240 down into the right bumper box 7220. This allows the user to control the virtual right stick control 7240 and the virtual right bumper control 7200 with a single finger. While in the right bumper box 7220 the user may move her finger in a circular direction to manipulate the virtual rights to control 7240.

The virtual right stick push control 7160, located in right stick box 7180, causes the same command to be generated as depressing the right stick on a gamepad. The virtual right stick push control 7160 may be tapped or held down by keeping a finger on the control. Alternatively, the user may control the virtual right stick control 7240 and press the virtual right stick push control 7160, by dragging the virtual right stick control 7240 across into the right stick box 7180. This allows the user to control the virtual right stick control 7240 and the virtual right stick push control 7160 with a single finger. While in the right stick box 7180 the user may move her finger in a circular direction to manipulate the virtual right stick control 7240.

The left zone 7400 includes a left stick group 7430. The left stick group 7430 may have a floating location established the first time the user touches the left zone 7400. In one aspect, the virtual left stick control 7540 is centered on the first contact with the left zone 7400. Prior to the first touch, an annotation can be presented in fighting the user to establish the location of the left stick group 7430 by touching the screen.

In one aspect, virtual control interface determines whether the initial touch was by a thumb or finger. This detection can be made by analyzing the shape and size of a contact zone with the touch screen interface. Games where the virtual left stick control 7540 is optimally manipulated by a thumb may reject initial touch not made by a thumb and instead instruct the user to hold the touch screen device in a way where his thumb may be used to manipulate the virtual left stick control 7540. A similar analysis may be performed on other virtual controls to determine whether the user is interacting with the controls in an optimal fashion. Areas for improvement may be communicated to a user to help the user efficiently use the virtual control interface 7050.

The controls associated with the left stick group 7430 may operate in the same way as the controls within the right stick group 7110. The various controls may include different game aspects, but may be manipulated in a similar manner. The left stick group 7430 includes the virtual left stick control 7540 located within left stick box 7520, virtual left trigger control 7440 located within left trigger box 7460, virtual left stick push 7480 located within stick push box 7500, and virtual left bumper control 7560 located within left bumper box 7580. The left zone also includes a virtual direction pad 7600. The virtual direction pad can be fixed to a specific location.

Annotations can be provided that help the user understand how to use the virtual control interface. Annotation 7700 communicates that pushing the bumper and the left stick down will cause the user's character to perform a dropkick. The annotation could match the game title playing on a separate magnetic gaming device. Annotations can be specific to particular purposes of the controller. For example, an annotation, taking the form of a hint, may be provided upon observing that the user is having difficulty overcoming a task associated with the controller. Annotations can also be provided as an initial tutorial for the virtual control interface 7050 associated with the magnetic device.

Other embodiments may include a magnetic connector with a magnetic device on magnetic musical instruments. A magnetic musical instrument can include a magnetic docking bay and related software for sensing music played by the magnetic musical instrument. The musical instrument can include a guitar, piano, etc. and the magnetic device can be connected thereto. Sensors of the magnetic device can include an audio sensor (e.g. a microphone) or an audio sensor of the magnetic musical device.

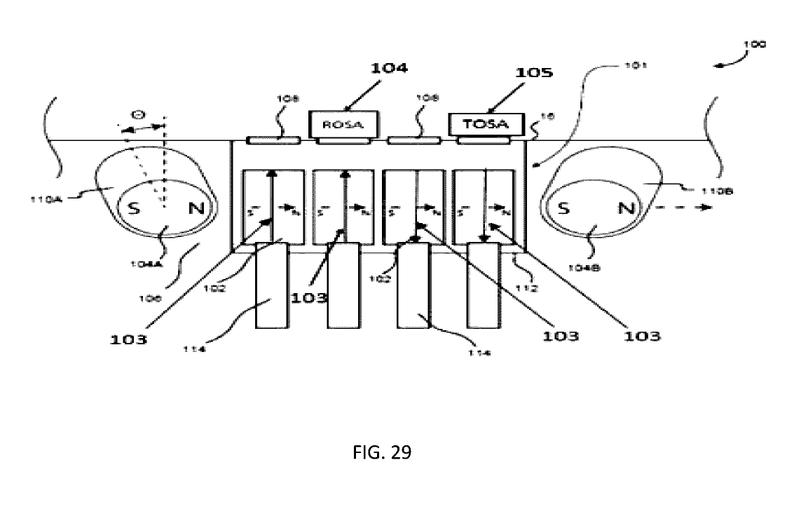

Other embodiments may include a magnetic connector with fiber optic communications. In FIG. 29, a modified fiber optic version of FIG. 3A illustrates a magnetic connector 100 including one or more optical fibers 114 for transmitting optical signals 102 there through. The optical fibers 114 can transmit and receive optical signals 103 and the magnetic connector 100 can include one or more lenses 108 for focusing or otherwise conditioning the optical signals 103.

The magnets 102 can include internal optical waveguides 103, such as internal optical fibers, that transmit the optical signals 103 there through to the optical lenses 108. In this example, the optical magnetic connector 100 can be in optical communication with a receive optical subassembly (ROSA) 104 and/or a transmit optical subassembly (TOSA) 105. An optical magnetic connector 100 can be particularly advantageous where high-speed data communications are present and electro-magnetic interference is to be avoided.

As illustrated in FIG. 29, the top housing is omitted for purposes of illustration. Further the connector can be a passive connector without the TOSA 105 and ROSA 104 and associated active components as illustrated in FIG. 3A.

This example arrangement includes a magnetic contact assembly 101 with four magnets 102 (which may be referred to as “core magnets”, each with the internal waveguide 103), received a connector housing 106 and movable in a path defined by a guide, such as a channel 112. Connector 100 further includes two side magnets 104A and 104B disposed within connector housing 106. Housing 106 may be formed from suitable materials that are insulating and may be readily shaped, such as, e.g., polybutylene terephthalate (“PBT”), polyethylene terephthalate (“PET”), or the like. Housing 106 may be integral with device housing 14 or may be a separate component received within housing 14. Some embodiments described herein include a discrete connector housing (e.g. housing 106). In other embodiments, the connector housing is integral with the device housing (e.g. housing 14). These possibilities are interchangeable. Accordingly, references to a device housing (e.g. housing 14 could be replaced with a discrete connector housing (e.g. housing 106) and vice-versa. Optical conditioning elements 108 may be formed from any suitable optically conductive (e.g., glass or transmissive polymer) material.

Magnetic contact assembly 101 is contained in a channel 112 formed in housing 106. Channel 112 acts as a guide. Magnetic contact assembly is slidable along a path defined by channel 112 between a withdrawn position in which magnets 102 are spaced inwardly from surface 16, as illustrated in FIG. 3A, and an extended position, in which magnets 102 abut terminals 108 to form an electrical connection between terminals 108 and the respective leads 114.

Side magnets 104A and 104B are disposed in channels 110A and 110B, respectively. Channels 110A and 110B are formed in housing 106 of connector 100 on right and left sides of core magnets 102, respectively. Channels 110A and 110B act as guides and define paths which extend inwardly away from surface 16 and converge towards one another and toward channel 112. As illustrated, channel 110A is oriented at an angle θ away from the normal line of surface 16 while channel 110B is oriented at an opposite angle. Each of channels 110A and 110B has a first end proximate surface 16 and a second end farther away from surface 16 and closer to channel 112 and thus, magnetic contact assembly 101. Each of channels 110A and 110B is formed such that each of magnets 104A and 104B may slideably move along a path defined by its respective channel between an extended position at the first end and a withdrawn position at the second end, i.e., to be closer or farther from surface 16.

Further, channels 110A and 110B and side magnets 104A and 104B are shaped such that each side magnet may rotate within its respective channel. Each of magnets 104A and 104B may rotate between a first orientation in which the magnets are oriented with a north-south alignment parallel to surface 16 and a second orientation in which the magnets are oriented with a north-south alignment diagonal relative to surface 16.

In the illustrated embodiment, each of side magnets 104A and 104B has a cylindrical shape, and the channels 110A and 110B are formed to allow each side magnet to rotate about its cylindrical axis. In other embodiments, each of side magnets 104A and 104B may have a different shape allowing each to rotate between the noted first and second orientations. For example, each of side magnets 104A and 104B may have a spherical shape, a hemispherical shape, an ovoid shape, etc.

FIG. 29 shows side magnets 104A and 104B each positioned at the second end of the respective channel 110A or 110B, retracted from surface 16 similar to FIG. 3A. Magnetic contact assembly 101 is also in a position retracted from surface 16 (and terminals 108). Magnets 102, 104A and 104B assume the illustrated positions when the connector 100 is not engaged with a complementary connector, which may be referred to as a “resting” state, a “retracted”, or a “disengaged” state of the connector 100.

Magnets 102, 104A and 104B are drawn towards the illustrated positions because of mutual attraction between magnets 102, 104A and 104B. Mutual attraction between magnets 102, 104A, and 104B causes side magnets 104A and 104B to move along a respective channel 110A or 110B towards magnets 102 and towards one another. As side magnets 110A and 110B move towards magnets 102, the angle of the channel causes the side magnets to move away from surface 16. The mutual attraction between magnets 102, 104A, and 104B also draws magnets 102 away from surface 16. Further, this mutual attraction causes side magnets 104A and 104B to rotate such that they have the same north-south alignment as magnets 102, i.e., parallel to surface 16.

In this way, mutual attraction between magnets 102 of magnetic contact assembly 101 and side magnets 104A and 104B biases each of the magnets towards a retracted position away from surface 16. Conveniently, no mechanical biasing is required. With magnets 102, 104A, and 104B in their retracted positions, connector 100 is in a disengaged state and terminals 108 are not electrically connected to the internal connectors or to the internal device circuit. Further, when connector 100 is in the “disengaged” state and magnets 102, 104A, and 104B are retracted from surface 16 magnetic flux at surface 16 may be significantly reduced. Conversely, connector 100 may be drawn into an engaged state, in which magnets 102, 104A, and 104B are in their respective extended positions, by an adjacent connector.

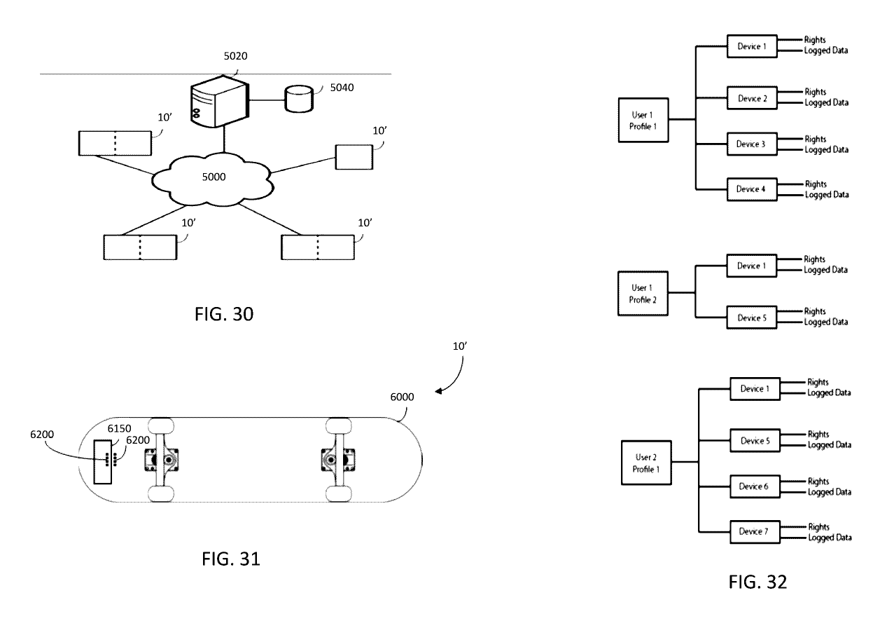

In some embodiments, as previously explained, the magnetic connector device can be used as a safety feature of an appliance and/or household devices as well as remote monitoring thereof. Multiple devices can be connected using the magnetic connecting devices. All the information gathered by the magnetic connector device can be stored in a database 5040, as illustrated in FIG. 30. The database 5040 may store records reflective of devices associated with users or user profiles. A user may have multiple profiles, suitable for different operating scenarios. The profiles may be for a child or adult and information may be shared or read/write privileges based on the user or control of the user's device or associated settings by another user. There may also be privacy aspects to each profile.

The records may store data reflective of logged sensor data transmitted to server 5020. The records may store data reflective of access rights to devices. For example, rights may include rights to connect to devices, rights to read from sensors at devices, rights to activate actuators at particular devices. Rights may be circumscribed in time, e.g., with defined start times and stop times.

Server 5020 maintains records of devices linked to a user profile. Server 5020 may analyze such records to identify combinations of related/linkable devices to suggest activities for users utilizing identified combinations. For example, server 5020 may determine that a particular user profile has associated with it a hot plate device, and a temperature sensor device. Based on this, server 5020 may suggest the user build a sous vide immersion cooking apparatus, and provide suitable build instructions. Optionally, server 5020 may store additional information regarding each device's capabilities, including, e.g., whether the temperature sensor device is submersible, the temperature range/wattage of the hot plate device, etc. Server 5020 may take into account such additional information when generating suggested activities. Optionally, server 5020 may suggest additional devices that a user should acquire or gain rights for, in order to complete particular activities.

In some embodiments, if the device is a skateboard, as illustrated in FIG. 31, database 5040 may store records reflecting the right of a user under a user profile to read from an accelerometer embedded in the skateboard. In another example, if the device is a washing machine (as illustrated in FIG. 25B), database 5040 may store records reflecting the right of a user under a user profile to operate the machine (e.g., start a wash cycle). In yet another embodiment, if the device is a vehicle (as illustrated in FIG. 25C), database 5040 may store records reflecting the right of a user under a user profile to start the engine, to activate the car radio, to read from engine sensors, etc.

As illustrated in FIG. 31, in an exemplary embodiment, a user may attach a magnetic connector device 6100 to a device 6000 with magnetic connectors 6200. FIG. 31 illustrates an exemplary device 6150 (e.g., a smartphone, smartwatch, or the like) connected to a device 6000 that is a skateboard. As explained above, the device 6000 is not limited to a skateboard. The application is equally applicable to cars, household appliances, drones, etc.

Detection at device 6100 of the magnetic connection provided by the magnetic connectors 6150 may cause device 6150 to enable a wireless interface for communication with device 6000. Similarly, detection at device 6000 of the magnetic connection provided by the magnetic connectors 6200 may cause device 6000 to enable a wireless interface for communication with device 6150. This wireless connection may be used by device 10 and device 6000 to perform handshaking.

Optionally, device 6150 may transmit a request to server 5020 for access to device 6000 or portions (e.g., components/features) thereof. Server 5020 processes that request based on the access rights granted to a particular user profile, as stored in database 5040. Following handshaking, and if a request to access device 6000 is granted, a session is instantiated at device 6150 for data communication with device 6000. In some embodiments, data may be communicated wirelessly. In some embodiments, data may be communicated through electrical connection established through the magnetic connectors 6200.

The session may be instantiated using a token or other code received from server 5020 for gaining access to device 6000 or portions thereof. The session may be instantiated in association with a particular user, and/or a particular user profile. The session may be instantiated upon verifying the identity of the user, e.g., using suitable sensors such as a fingerprint sensor at device 6150 or device 6000, or using a password or other code supplied by the user. Verification may be performed by device 6150, device 6000, server 5020, or some/all in cooperation.

Instantiation of a session at device 6150 may include creating a data structure reflecting states of the devices and user data. State/user data may be carried from a previous session, as may be stored at device 6150 or server 5020. Optionally, device 6150 may obtain an identifier of device 6000, its type (e.g., whether it is a washing machine, a vehicle, a skateboard), and/or an enumeration of its features (e.g., available sensors, actuators, input/output interfaces). Optionally, device 6150 may download software (e.g., drivers) from server 5020 to interface with device 6000 (e.g., for accessing sensors) or for processing data logged from sensors. Optionally, a device 6150 may download software (e.g., firmware) from server 5020 to update software that executes at device 6000.

Following handshaking and instantiation of a session spanning device 6150 and device 6000, device 6150 gains access to features/components of device 6000, e.g., its sensors. As noted, the amalgam of device 6150 and device 6000 may be referred to as amalgamated device 10′. During this session, as amalgamated device 10′ is being operated by the user, device 6150 may log data captured by one or more of sensors of device 10′. Device 6150 may log data from sensors at device 6150 and sensors from device 6000, in combination. Optionally, a power link may be established between device 6150 and device 6000. Direction of power transfer across this link may be controlled by device 6150.

In other embodiments, the device 6150 may include a sensor that is a GPS sensor and the device 6000 (e.g., a skateboard) may also include sensors that are an accelerometer and gyroscope, respectively. As a user operates the skateboard, device 6000 may read from this GPS sensor and the accelerometer and the gyroscope. Sensor data may be stored at device 6150 and/or transmitted to server 5020. Such data may be stored by server 5020 in database 5040 for later processing using various analytics techniques. For example, GPS sensor data may be analyzed to determine route/speed information. The accelerometer/gyroscope data may be analyzed to identify actions performed by the user on the skateboard. Some or all the analysis may also be performed at device 6150. Sensor data and/or analysis results for multiple user profiles may be compared (e.g., to compare skill levels), or aggregated at server 5020 to determine population trends/statistics.

In other embodiments, device 6150 may have no sensors but be connected to another device, such as a car, that has a plurality of sensors (e.g., engine sensors, fuel level sensors, speedometer, etc). Device 6150 may log data from such sensors. Such data may be analyzed, for example, to analyze engine performance and to suggest maintenance operations to the user. Notifications of suggested maintenance may be sent to device 6150. Such data may be analyzed to determine duration of use, fuel consumed, etc., by a particular user, e.g., so that the user may be charged for such use. Device 6150 may also provide an interface (e.g., a touch and/or display interface) allowing users to control various components of the vehicle (e.g., start the engine, tune the radio, adjust the mirrors, etc.).

In other embodiments, device 6150 may log data about temperature or water level from a device, such as a washing machine. Device 6150 may log such data. Such data may be analyzed at device 6150 or server 5020 to determine, e.g., when to add detergent or fabric softener. Electronic notifications may be automatically sent to a user associated with the session, based on such analysis. Data over multiple wash cycles may be analyzed to monitor water consumption over a period of time.

A user may detach device 6150 from device 6000. Upon detecting the disconnection of the electrical connection, device 6150 may terminate the session. State/user data for the session may be stored at device 6150 or at server 5020.

As illustrated in FIG. 32, multiple users may be associated with the same device (e.g., device 1). For example, device 1 may be a vehicle in a car-sharing fleet (e.g., a Zipcar fleet). Access rights to the device, however, may be time-divided amongst multiple users. Rights may be granted to a user, upon request from that user. For example, the right to connect to a device may be requested by a user prior to or upon connection to a device. Rights may be granted to a user upon payment of a fee (e.g., a device rental fee). Rights may also be granted upon request to server 5020 by another user, e.g., the owner of a device may grant rights for that device to other users. In these manners, devices, portions thereof, and hardware utility may be shared amongst multiple users.

Although the disclosure has been described and illustrated with respect to exemplary arrangements and embodiments with a certain degree of particularity, it is noted that the description and illustrations have been made by way of example only. Numerous changes in the details of construction and combination and arrangement of parts and steps may be made.

1. A system for mechanical connection comprising:
a first communication device having an interface;
a second communication device having an interface;
wherein each device comprises a housing with a peripheral surface configured to receive a connector comprising a magnetic contact assembly; and
wherein the first and second device are positioned at said interfaces through magnetic attraction of the magnetic contact assemblies.

2. The system of claim 1, wherein the connector comprises a first and a second guide defining first and second paths, respectively, within said housing.

3. The system of claim 2, wherein said magnetic contact assembly comprises a core magnet slidably received in said housing and a plurality of conductive leads.

4. The system of claim 3, wherein said contact assembly is magnetically movable along said first path between a first, extended position for joining said connector with an adjacent connector, and a second position withdrawn from said peripheral surface.

5. The system of claim 1, wherein the system comprises at least three devices connected together using one or more connectors.

6. The system of claim 4, wherein said magnet is movable by attraction to an adjacent connector along said second path, from a retracted position to an extended position closer to said peripheral surface and farther from said first path for magnetically holding said connector to said adjacent connector.

7. The system of claim 6, wherein said second path is configured so that said magnet and said magnetic contact assembly magnetically bias one another along said first and second paths to said retracted position and said second position, respectively.

8. The system of claim 7, wherein said second device comprises a magnet and a magnetic contact assembly, further comprising: magnetically drawing a magnet of said second device toward said first device, thereby overcoming a magnetic bias between said magnet and a contact assembly of said second device; and magnetically drawing said contact assembly of said second device toward said first device.

9. The system of claim 1, wherein the connector comprises a plurality of magnets disposed along a connecting surface of the connector.

10. The system of claim 9, wherein the plurality of magnets is arranged to have a plurality of non-uniform magnetic orientations comprising a magnetic orientation substantially parallel to the connecting surface and a magnetic orientation diagonal to the connecting surface, such that the connector selectively connects to other connectors having magnets arranged with magnetic orientations matched to the plurality of magnetic orientations.

11. The system of claim 10, wherein the plurality of magnetic orientations is symmetrical.

12. The system of claim 10, wherein the plurality of magnetic orientations is asymmetrical.

13. The system of claim 8, wherein the magnet of said first device rotates to magnetically engage a magnet of another connector to form an electrical connection between the two magnets.

14. The system of claim 13, wherein the electrical connection comprises a data path.

15. The system of claim 13, wherein the electrical connection comprises a power path.

16. A method of connecting devices, comprising:
positioning a connector of a first device adjacent a connector of a second device;
magnetically drawing a magnet of said first device toward said second device to magnetically hold said first and second devices together, thereby overcoming a magnetic bias between said magnet and a contact assembly of said first device; and
magnetically drawing said contact assembly toward said second device to form a mechanical connection.

17. The method of claim 16, further comprising pivoting said first and second devices relative to one another without breaking said mechanical connection.

18. The method of claim 16, further comprising magnetically drawing said contact assembly toward said second device to form a data connection.

19. The method of claim 18, further comprising pivoting said first and second devices relative to one another without breaking said data connection.

20. The method of claim 17, further comprising removing said second device from said first device and withdrawing said magnet and said contact assembly of said first device by magnetic attraction between said magnet and said magnetic contact assembly.
